(19) United States
(12) Patent Application Publication
(10) Pub. No.: US 2025/0287279 A1
(43) Pub. Date: Sep. 11, 2025

(54) NOTIFICATION OF SGW CHANGE FOR ONE OR MORE PDN CONNECTIONS WHEN COMBINED SGW/PGW/SMF SET IS DEPLOYED

(71) Applicant: Telefonaktiebolaget LM Ericsson (publ), Stockholm (SE)

(72) Inventor: Yong Yang, Kållered (SE)

(21) Appl. No.: 18/572,455

(22) PCT Filed: Jun. 2, 2022
(86) PCT No.: PCT/EP2022/065115

§ 371 Date: Dec. 20, 2023

Related U.S. Application Data
(60) Provisional application No. 63/215,040, filed on Jun. 25, 2021.

(51) Int. Cl. H04W 36/12; H04W 36/00

(52) U.S. Cl. CPC H04W 36/12; H04W 36/0055

(57) ABSTRACT

Disclosed herein is a method performed by a core network node. The method comprises: establishing one or more PDN connections with a first combined SGW/PGW/SMF, wherein: the first combined SGW/PGW/SMF is comprised in a combined SGW/PGW/SMF set; and a SGW of the first combined SGW/PGW/SMF has a first address. The method further comprises: receiving a notification of an SGW address change for the one or more PDN connections, the notification of the SGW address change comprising a second address of a SGW of a second combined SGW/PGW/SMF, the second combined SGW/PGW/SMF being comprised in the combined SGW/PGW/SMF set; and initiating a PDN connection restoration procedure towards the SGW of the second combined SGW/PGW/SMF using the second address of the SGW of the second combined SGW/PGW/SMF comprised in the notification of the SGW address change.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In Release 17, Third Generation Partnership Project (3GPP) has introduced a new restoration procedure, which is referred to as restoration of Packet Data Network (PDN) connections after a PDN Gateway Control Plane (CP) part (PGW-C)/Session Management Function (SMF) change, as specified in clause 31 of 3GPP Technical Specification (TS) 23.007 V17.0.0. This procedure enables a PGW/SMF to take over one or more PDN connections that were handled by another PGW/SMF pertaining to the SAME PGW/SMF set.

The following contains some more information about motivations to introduce such a new restoration procedure.

### FIG. 1

In order to support mobility between Fourth Generation (4G) and Fifth Generation (5G), a combined PGW and SMF (sometimes referred to as a “SMF+PGW-C”) is required. See FIG. 1, which is a reproduction of FIG. 4.3.1-1 (“Non-roaming architecture for interworking between 5GS and EPC/E-UTRAN”) from 3GPP TS 23.501 V17.0.0.

### FIGS. 2 and 3

Without the SMF Set concept, e.g. for the Evolved Packet System (EPS) (see, e.g., FIG. 2 which is a reproduction of FIG. 4.2.1-1 (“Non-roaming architecture for 3GPP accesses”) from 3GPP TS 23.401 and FIG. 3 which is a reproduction of FIG. 4.2.2-1 (“Roaming architecture for 3GPP access. Home routed traffic”) from 3GPP TS 23.401), when a PGW is failed, i.e., without restart or has restarted, the PDN connections which were handled by this PGW can NOT be retained, the MME has to request UEs to REESTABLISH the affected PDN connections.

So, with this new restoration procedure, the PDN connection can be restored by another PGW/SMF in the same PGW/SMF set to which the failed PGW/SMF pertain.

### FIG. 4

FIG. 4 is a reproduction of FIG. 4.2.1-1 (“Architecture reference model with separation of user plane and control plane for non-roaming and roaming scenarios”) from 3GPP TS 23.214, which illustrates the network scenario where the control plane and user plane are separated. In the present disclosure, it is assumed that the User Plane (UP) part of the Serving Gateway (SGW), i.e., the SGW-U, is still up and running, so it motivates an optimization. The user plane path, from Operator's Internet Protocol (IP) services over SGi, PGW-U, SGW-U and over S1-U to the evolved Node B (eNB) may be fine.

At CT4 #104e meeting, Huawei submitted a discussion paper (C4-213079 entitled “Combined S/PGW restart and PGW-C/SMF change”) which considers a use case where a combined SGW/PGW is deployed in the network. So far, they have just considered to possible amendment to request the MME to re-establish the PDN connection if detecting it is a combined SGW/PGW, as described in C4-213588 which is a Change Request (CR) entitled “Combined S/PGW restart”.

The requirements for restoration of PDN connections after a PGW-C/SMF change are specified in Clause 31 of 3GPP TS 23.007, which is reproduced below.

### SUMMARY

There currently exist certain challenge(s). Further optimization of the new restoration procedure (as mentioned in the background information) is desired.

With respect to the MME triggered PDN connection restoration procedure specified in Clause 31.3 of 3GPP TS 23.004 and illustrated in FIGS. 31.3-1 of 3GPP TS 23.004, which is reproduced herein as FIG. 6, the requirements specified in clause 31.3 of TS 23.007 in regard to step 4 of the procedure reads, in pertinent part:
The MME shall send a Create Session Request including a PGW Change Indication towards the newly selected PGW-C/SMF, via the same or a different SGW. The MME may defer doing so until it needs to send signalling to the SGW or PGW-C. The MME should reuse the same SGW if possible, since the PDN connection restoration remains then transparent to the eNodeB. The PGW Change Indication tells the SGW and PGW-C/SMF that this is a request to move an existing PDN connection to the new PGW-C/SMF.

The intention to select the old SGW is to try to reuse the old SGW-U so that the existing SGW-U Fully Qualified Tunneling Endpoint Identifier (F-TEID) (for the eNB to send uplink traffic) can be used without triggering signaling towards the eNB to provide a new SGW-U F-TEID, as would be the case if the SGW-U has to be changed.

When a combined SGW/PGW/SMF has failed, the MME is unable to select the old combined SGW-C/PGW-C and, as such, the PDN connection restoration in this scenario cannot remain transparent to the eNB when using the existing solution.

Certain aspects of the present disclosure and their embodiments may provide solutions to the aforementioned or other challenges. Systems and methods are disclosed herein for providing a new mechanism to request that a Mobility Management Entity (MME) may select a new Serving Gateway (SGW) (which is also a combined SGW/PGW) for one or more PDN connections as indicated in PGW Change Info if the combined SGW/PGW/SMF has failed and another combined SGW/PGW/SMF pertaining to the same SGW/PGW/SMF set as the failed one is taking over these PDN connections. In other words, systems and methods are disclosed herein in which, when a combined SGW/PGW/SMF has failed, the MME is able to select a new combined SGW/PGW/SMF in the same combined SGW/PGW/SMF set and initiate PDN connection restoration using the new combined SGW/PGW/SMF from the same combined SGW/PGW/SMF set as the failed one. This enables PDN connection restoration to be transparent to the eNB.

There are, proposed herein, various embodiments which address one or more of the issues disclosed herein.

Certain embodiments may provide one or more of the following technical advantage(s). Embodiments of the present disclosure may enable the MME to select the combined SGW/PGW which is taking over of these PDN connections affected by a combined SGW/PGW failure.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 4.3.1-1 (“Non-roaming architecture for interworking between 5GS and EPC/E-UTRAN”) from 3GPP TS 23.501 V17.0.0;

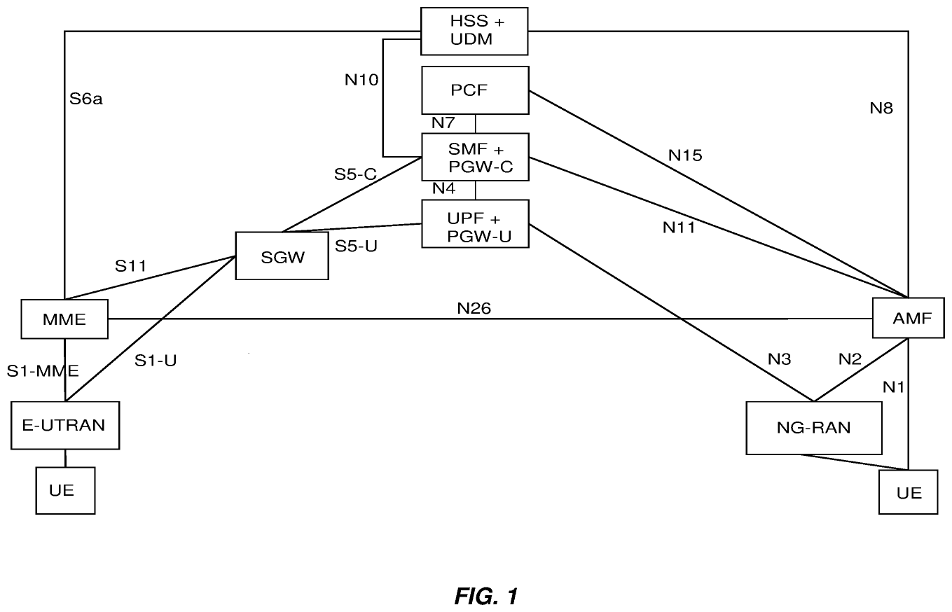

FIG. 2 is a reproduction of FIG. 4.2.1-1 (“Non-roaming architecture for 3GPP accesses”) from 3GPP TS 23.401; is a reproduction of FIG. 4.2.2-1 (“Roaming architecture for 3GPP access. Home routed traffic”) from 3GPP FIG. 3 TS 23.401;

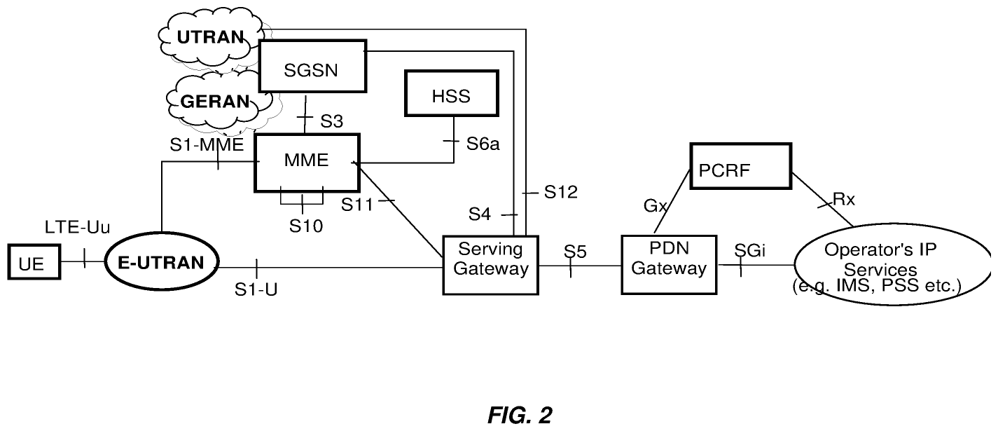

FIG. 4 is a reproduction of FIG. 4.2.1-1 (“Architecture reference model with separation of user plane and control plane for non-roaming and roaming scenarios”) from 3GPP TS 23.214;

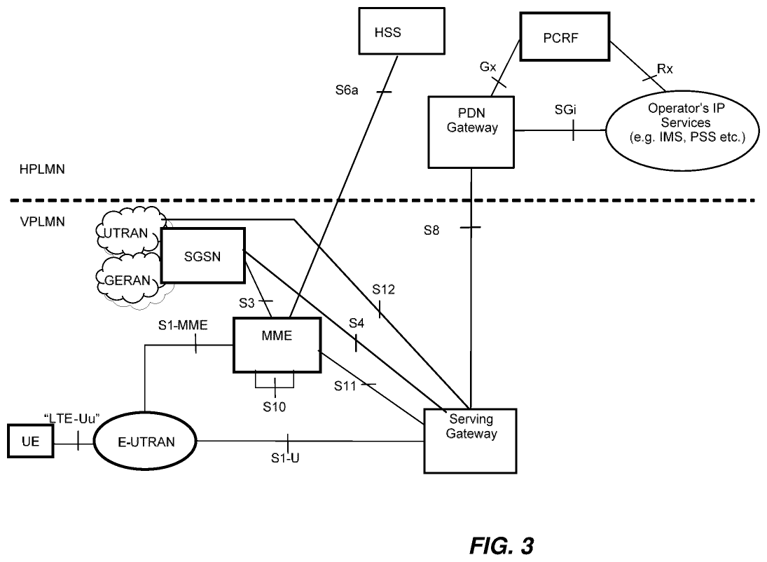

FIG. 5 is a reproduction of FIGS. 31.2-1 (“PDN connection establishment”) from 3GPP TS 23.401;

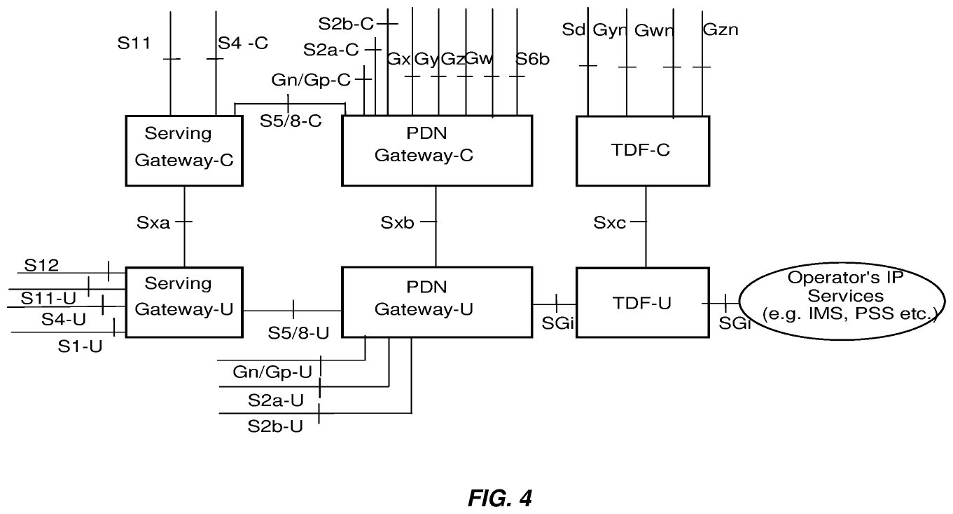

FIG. 6 is a reproduction of FIGS. 31.3-1 (“MME triggered PDN connection restoration”) from 3GPP TS 23.401;

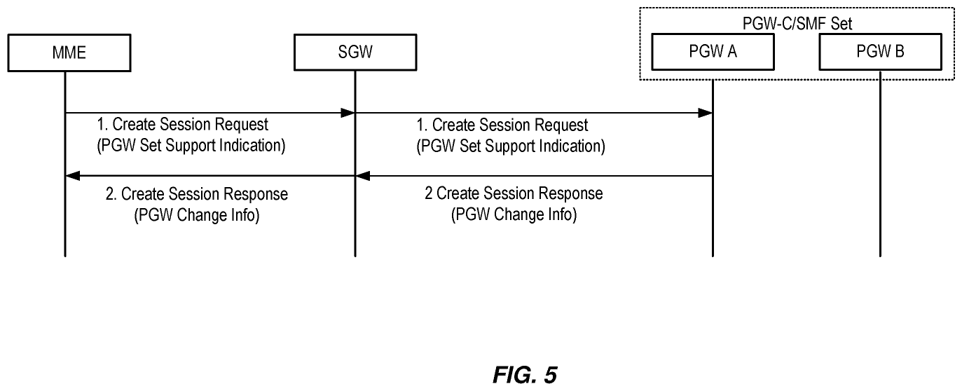

FIG. 7 is reproduction of FIGS. 31.4-1 (“PGW triggered PDN connection restoration”) from 3GPP TS 23.401;

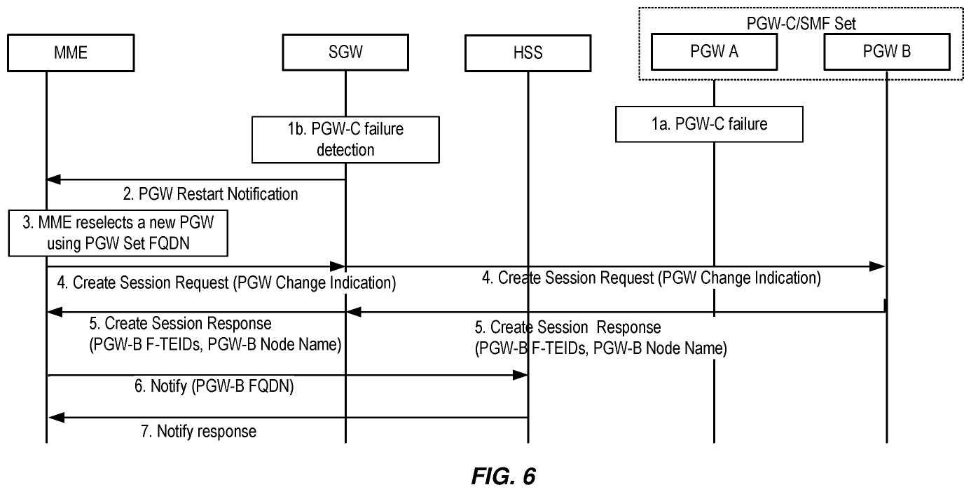

FIG. 8 illustrates one example of a cellular communications system 800 in which embodiments of the present disclosure may be implemented:

FIG. 9 illustrates one example embodiment of the wireless communication system 800 of FIG. 8;

FIG. 10 illustrates procedure for MME-triggered PDN connection restoration in which the failed PGW is part of a combined SGW/PGW/SMF 902 in accordance with embodiments of the present disclosure;

FIG. 11 is a schematic block diagram of a network node 1100 according to some embodiments of the present disclosure;

FIG. 12 is a schematic block diagram that illustrates a virtualized embodiment of the network node 1100 according to some embodiments of the present disclosure;

FIG. 13 is a schematic block diagram of the network node 1100 according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Network Function (NF) Service Set: A group of interchangeable NF service instances of the same service type within an NF instance. The NF service instances in the same NF Service Set have access to the same context data.

NF Set: A group of interchangeable NF instances of the same type, supporting the same services and the same Network Slice(s). The NF instances in the same NF Set may be geographically distributed but have access to the same context data. A combined SGW-C/PGW-C/SMF set (i.e., a set of interchangeable SGW-C/PGW-C/SMF instances) and a combined PGW-C/SMF set (i.e., a set of interchangeable PGW-C/SMF instances) are two examples of an NF set.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

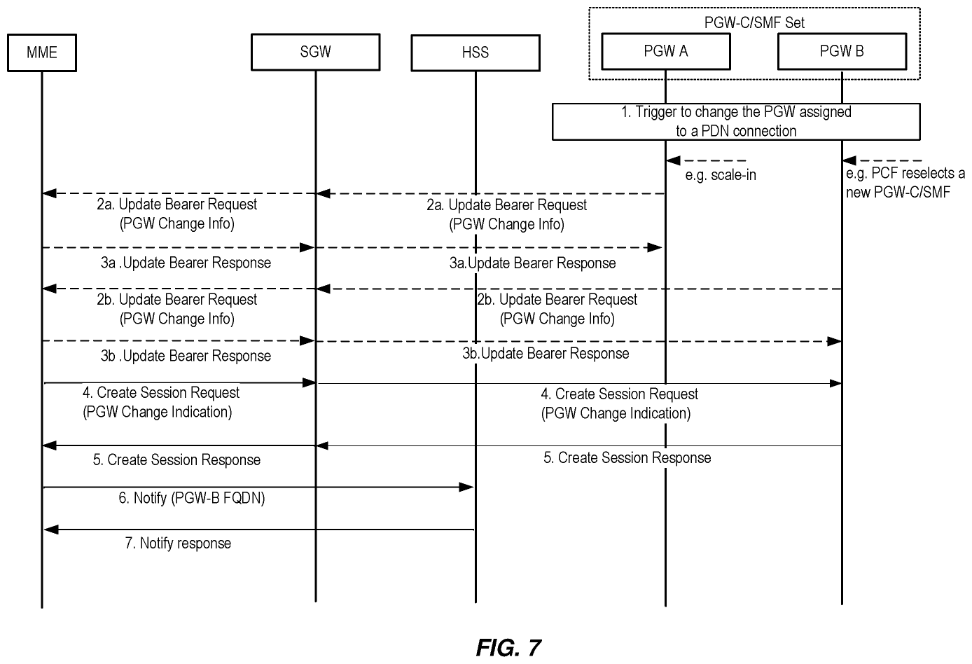

### FIG. 8

FIG. 8 illustrates one example of a cellular communications system 800 in which embodiments of the present disclosure may be implemented. In the embodiments described herein, the cellular communications system 800 allows inter-working between a 5G system (5GS) including a Next Generation RAN (NG-RAN) and a 5G Core (5GC) and an Evolved Packet System (EPS) including an Evolved Universal Terrestrial RAN (E-UTRAN) and an Evolved Packet Core (EPC); however, the solution(s) described herein are not limited thereto. In this example, the cellular communications system 800 includes a E-UTRAN including an E-UTRAN node 802 (e.g., an eNB) controlling a respective cell(s) 804 and a NG-RAN including a NG-RAN node 806 (e.g., a gNB) controlling a respective cell(s) 808.

The cellular communications system 800 also includes an EPC 810 and 5GC 812, where at least one combined core network node 814 (e.g., a combined SGW-C/PGW-C/SMF, which is also denoted herein simply as a combined SGW/PGW/SMF) enables interworking between the EPS and the 5GS. As used herein, a “combined core network node” is a network node that implements the functionality of two or more NFs. For example, a combined SGW/PGW/SMF is a network node that implements the functionality of a SGW-C, a PGW-C, and a SMF.

The E-UTRAN node 802 and the NG-RAN node 804 provide service to wireless communication devices 816 in the corresponding cells 804 and 808. In the following description, the wireless communication devices 816 are oftentimes UEs and as such sometimes referred to herein as UEs 816, but the present disclosure is not limited thereto.

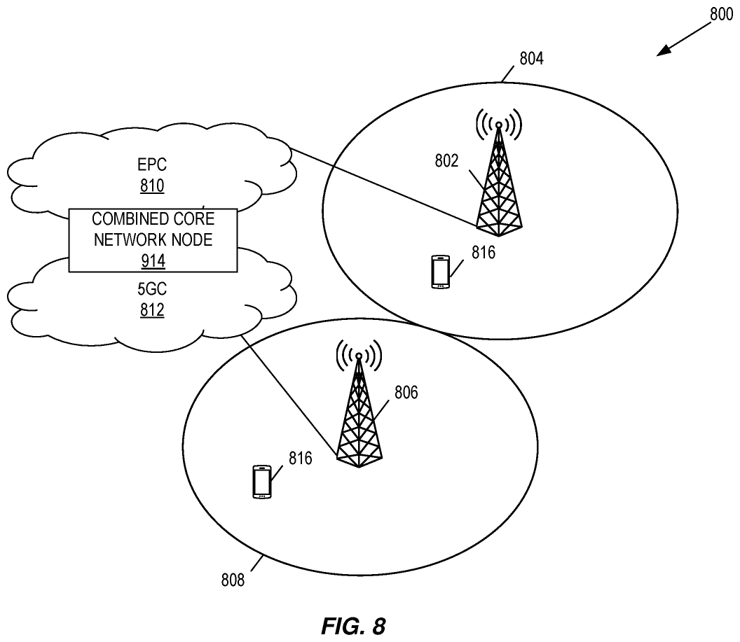

### FIG. 9

FIG. 9 illustrates one example embodiment of the wireless communication system 800 of FIG. 8. This example illustrates the details of the EPC 810 and 5GC 812 in more detail. In this example embodiment, there are several combined core network nodes 814, namely, a combined HSS/UDM 900, a combined SGW-C/PGW-C/SMF 902 (also denoted herein as combined SGW/PGW/SMF 902), and a combined SGW-U/PGW-U/UPF 904 (also denoted herein as combined SGW/PGW/UPF 904). The EPC 810 also includes an MME 906. The 5GC 812 also includes an AMF 908 and a PCF 910.

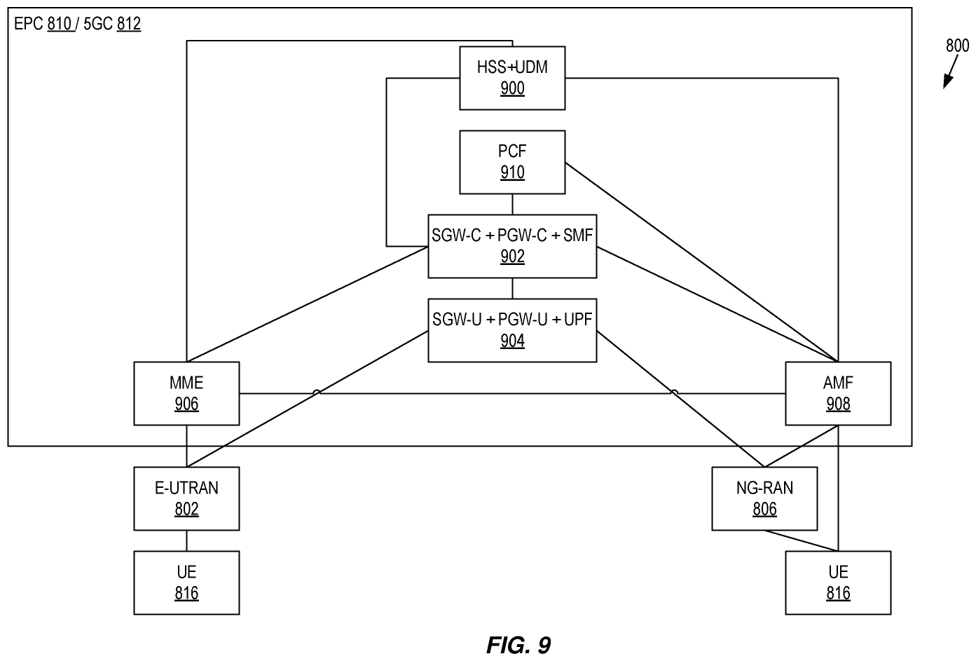

### FIG. 10

FIG. 10 illustrates procedure for MME-triggered PDN connection restoration in which the failed PGW is part of a combined SGW/PGW/SMF 902 in accordance with embodiments of the present disclosure. Optional steps are represented by dashed lines/boxes. As illustrated, the MME 906 establishes a number (N) of PDN connections (e.g., a

PDN connection for a particular Access Point Name (APN), which is denoted here as APN1, and optionally one or more additional PDN connections) with a first combined SGW/PGW/SMF 902-1 (also referred herein as combined SGW1/PGW1/SMF1 902-1) (step 1002). The first SGW/PGW/SMF 902-1 is part of a combined SGW/PGW/SMF set 1000 that also includes a second combined SGW/PGW/SMF 902-2 (also referred to herein as combined SGW2/PGW2/SMF2 902-2). Here, N is a positive integer that is greater than or equal to 1. Note that, the combined SGW/PGW/SMF set 10090 is a set of interchangeable combined SGW/PGW/SMF instances, where the PDN connections and PDU session contexts are bound to the set so that any SGW/PGW/SMF instance in the set can manipulate (e.g., update, delete, and/or create) these contexts.

In this example, the first combined SGW/PGW/SMF 902-1 fails or is otherwise taken offline (e.g., put into a maintenance mode or otherwise taken offline for any reason, e.g., by OAM) (step 1006). The second combined SGW/PGW/SMF 902-2 from the same SGW/PGW/SMF set 1000 is selected to take over for the first combined SGW/PGW/SMF 902-1. In one embodiment, the PCF 910 detects that the first combined SGW/PGW/SMF 902-1 has failed (or otherwise gone offline) (step 1008), possibly selects the second combined SGW/PGW/SMF 902-2 to take over for the first combined SGW/PGW/SMF 902-1, and sends a message to the second combined SGW/PGW/SMF 902-2 to trigger a bearer create/update/delete request message towards the MME 906 (step 1010). However, in one alternative embodiment, the second combined SGW/PGW/SMF 902-2 determines that the first combined SGW/PGW/SMF 902-1 has failed (or otherwise gone offline), e.g., based on a notification from another network node or in any other desired manner.

In the illustrated example, the second combined SGW/PGW/SMF 902-2 sends, to the MME 906, a notification of an address change (e.g., an IP address change or FQDN change) for the SGW associated to the N established PDN connections (step 1012). This notification is also referred to herein as a notification of a “SGW address change”. In one embodiment, the second combined SGW/PGW/SMF 902-2 sends the notification of the address change to the MME 906 in response from signaling from another network node (e.g., signaling from the PCF 910 in step 1008 or signaling from an OAM node). In one embodiment, the second combined SGW/PGW/SMF 902-2 sends the notification of the address change by sending a create/update/delete bearer request with one or more PGW change information IEs. In one embodiment, the second combined SGW/PGW/SMF 902-2 sends the notification of the address change by sending a create/update/delete bearer request with PGW change information IE(s) that includes a new SGW address (e.g., IP address or FQDN), e.g., in a new IE, which is preferably, but not necessarily, called “PGW Change Info”. The MME 906 may send an acknowledgement of the address change to the second combined SGW/PGW/SMF 902-2 (step 1014).

The MME 906 then performs an MME-triggered PDN connection restoration procedure using the new address (e.g., the new SGW address associated to SGW that is part of the second combined SGW/PGW/SMF 902-2) (step 1016). In one embodiment, this MME-triggered PDN connection restoration procedure is the procedure described in Clause 31.3 of 3GPP TS 23.007, but using the SGW address of the SGW that is part of the second combined SGW/PGW/SMF 902-2 as the “old” SGW. By doing so, the PDN connections (e.g., identified in the PGW change information of step 1012) can be restored (via the MME 906 and the second combined SGW/PGW/SMF 902-2) in a manner that is transparent to the E-UTRAN node 802.

It should be noted that, while in the example of FIG. 10, the combined SGW/PGW/SMF that sends the notification of the SGW address change to the MME 906 is the same combined SGW/PGW/SMF that includes the new SGW indicated by the new SGW address included in the notification, the present disclosure is not limited thereto. For example, in another embodiment, the notification of the SGW address change may be sent from the first combined SGW/PGW/SMF 902-1 (e.g., first combined SGW/PGW/SMF 902-1 isn't failing but, due to some other reason, e.g. for rebalancing the load, the first combined SGW/PGW/SMF 902-1 requests the MME 906 to re-establish the PDN connection(s) towards another combined SGW/PGW/SMF (e.g., the SGW/PGW/SMF 902-2) in the same set. In general, any combined SGW/PGW/SMF in the set can send the notification of the SGW address change to the MME 906.

It should also be noted that while the description above focuses on the notification of the SGW address change, the notification may also include a PGW address change (i.e., an address (e.g., IP address or FQDN) of a new PGW, i.e., the PGW in the new combined SGW/PGW/SMF (e.g., in the PGW Change Info IE(s)).

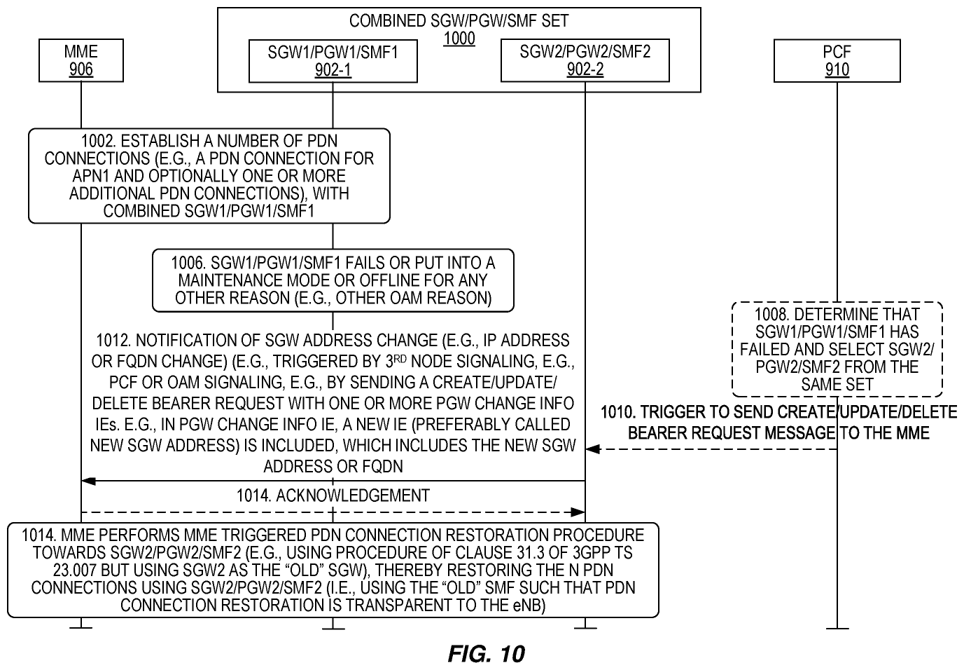

### FIG. 11

FIG. 11 is a schematic block diagram of a network node 1100 according to some embodiments of the present disclosure. Optional features are represented by dashed boxes. The network node 1100 may be, for example, a core network node such as, e.g., the MME 906, the first combined SGW/PGW/SMF 902-1, the second combined SGW/PGW/SMF 902-2, or the PCF 910. As illustrated, the network node 1100 includes a one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of the network node 1100 as described herein (e.g., one or more functions of the MME 906, the first combined SGW/PGW/SMF 902-1, the second combined SGW/PGW/SMF 902-2, or the PCF 910, as described herein). In some embodiments, the function(s) are implemented in software that is stored, e.g., in the memory 1106 and executed by the one or more processors 1104.

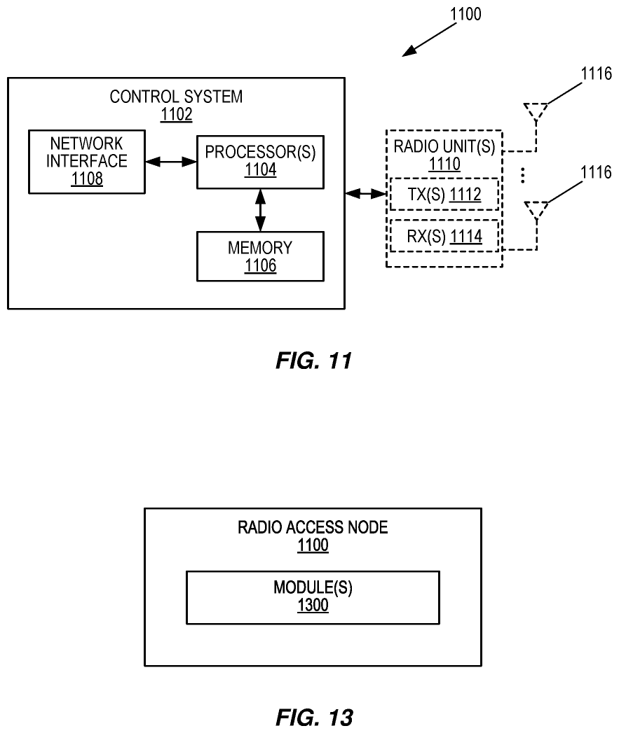

### FIG. 12

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. In this example, functions 1210 of the network node 1100 described herein (e.g., one or more functions of the MME 906, the first combined SGW/PGW/SMF 902-1, the second combined SGW/PGW/SMF 902-2, or the PCF 910, as described herein) are implemented at the one or more processing nodes 1200 or distributed across the two or more processing nodes 1200 in any desired manner. In some particular embodiments, some or all of the functions 1210 of the network node 1100 described herein are implemented as virtual components executed by one or more virtual machines implemented in a virtual environment(s) hosted by the processing node(s) 1200.

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

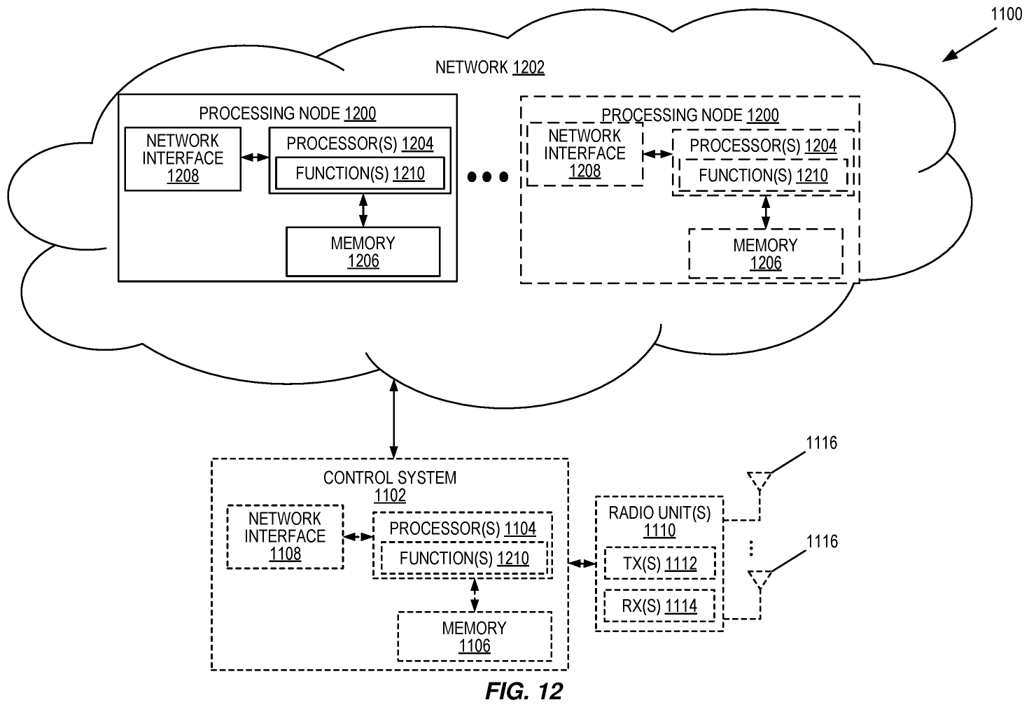

### FIG. 13

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein (e.g., one or more functions of the MME 906, the first combined SGW/PGW/SMF 902-1, the second combined SGW/PGW/SMF 902-2, or the PCF 910, as described herein). This discussion is equally applicable to the processing node 1200 of FIG. 12 where the modules 1300 may be implemented at one of the processing nodes 1200 or distributed across multiple processing nodes 1200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### SOME EMBODIMENTS

Some embodiments that have been described above may be summarized in the following manner:

1. A method performed by a core network node (906), the method comprising:
establishing (1002) one or more Packet Data Network, PDN, connections with a first combined SGW/PGW/SMF (902-1), wherein:
   the first combined SGW/PGW/SMF (902-1) is comprised in a combined SGW/PGW/SMF set (1000); and
   a SGW of the first combined SGW/PGW/SMF (902-1) has a first address;
receiving (1012) a notification of an SGW address change for the one or more PDN connections, the notification of the SGW address change comprising a second address of a SGW of a second combined SGW/PGW/SMF (902-2), the second combined SGW/PGW/SMF (902-2) being comprised in the combined SGW/PGW/SMF set (1000); and
initiating (1016) a PDN connection restoration procedure towards the SGW of the second combined SGW/PGW/SMF (902-2) using the second address of the SGW of the second combined SGW/PGW/SMF (902-2) comprised in the notification of the SGW address change.

2. The method of embodiment 1 wherein combined SGW/PGW/SMFs in the combined SGW/PGW/SMF set (1000) are interchangeable such that existing user plane entities for the one or more PDN connections are reused.

3. The method of embodiment 1 wherein combined SGW/PGW/SMFs in the combined SGW/PGW/SMF set (1000) are interchangeable such that user plane GTP tunnel endpoints in a RAN node and SGW-U node used for user plane traffic for the one or more PDN connections are not impacted.

4. The method of any of embodiments 1 to 3 wherein receiving (1012) the notification of the SGW address change comprises receiving (1012) the notification of the SGW address change from the second combined SGW/PGW/SMF (902-2).

5. The method of any of embodiments 1 to 3 wherein receiving (1012) the notification of the SGW address change comprises receiving (1012) the notification of the SGW address change from the first combined SGW/PGW/SMF (902-1).

6. The method of any of embodiments 1 to 3 wherein receiving (1012) the notification of the SGW address change comprises receiving (1012) the notification of the SGW address change from a combined SGW/PGW/SMF, other than the first combined SGW/PGW/SMF (902-1) or second combined SGW/PGW/SMF (902-2), in the combined SGW/PGW/SMF set (1000).

7. The method of any of embodiments 1 to 6 wherein receiving (1012) the notification of the SGW address change comprises receiving (1012) the notification of the SGW address change after the first combined SGW/PGW/SMF (902-1) has failed or otherwise gone offline.

8 The method of any of embodiments 1 to 7 wherein initiating the PDN connection restoration procedure comprises sending a create session request message for each of the one or more PDN connections to be restored to the SGW of the second combined SGW/PGW/SMF (902-2) using the second address of the SGW of the second combined SGW/PGW/SMF (902-2) comprised in the notification of the SGW address change.

9. The method of embodiment 8 wherein the second address of the SGW of the second combined SGW/PGW/SMF (902-2) is an IP address or FQDN.

10. The method of any of embodiments 1 to 9 wherein the notification of the address change comprises a create/update/delete bearer request messages comprising one or more PGW Change Info IEs, at least one of which comprises the second address of the SGW of the second combined SGW/PGW/SMF (902-2).

11. The method of embodiment 1 to 9 wherein the notification of the address change comprises a create/update/delete bearer request comprising one or more PGW Change Info IEs, at least one of which comprises an IE that comprises the second address of the SGW of the second combined SGW/PGW/SMF (902-2).

12. The method of any of embodiments 1 to 11 wherein the core network node (906) is an MME (906).

13. A method performed by a combined SGW/PGW/SMF, the method comprising:
sending (1012), to a core network node (906), a notification of an SGW address change for one or more PDN connections that are using a first combined SGW/PGW/SMF (902-1), wherein:
   the first combined SGW/PGW/SMF (902-1) is comprised in a combined SGW/PGW/SMF set (1000);
   a SGW of the first combined SGW/PGW/SMF (902-1) has a first address; and
   the notification of the SGW address change comprising a second address of a SGW of a second combined SGW/PGW/SMF (902-2), the second combined SGW/PGW/SMF (902-2) being comprised in the combined SGW/PGW/SMF set (1000)

14. The method of embodiment 13 wherein the combined SGW/PGW/SMF is the second combined SGW/PGW/SMF (902-2).

15. The method of embodiment 13 wherein the combined SGW/PGW/SMF is the first combined SGW/PGW/SMF (902-1).

16. The method of embodiment 13 wherein the combined SGW/PGW/SMF is a combined SGW/PGW/SMF, other than the first combined SGW/PGW/SMF (902-1) or second combined SGW/PGW/SMF (902-2), in the combined SGW/PGW/SMF set (1000).

17. The method of any of embodiments 13 to 16 further comprising determining that a change of a serving SGW and/or a serving PGW for the one or more PDN connections is needed (e.g., because the serving SGW or serving PGW has failed or to rebalance the load among the combined SGW/PGW/SMFs in the set).

18. The method of embodiment 13 or 17 further comprising receiving (1016), from the core network node (906), a message that initiates a PDN connection restoration procedure towards the second combined SGW/PGW/SMF (902-2) based on the notification of the SGW address change, wherein the PDN connection restoration procedure restores the one or more PDN connections with the second combined SGW/PGW/SMF (902-2).

19. The method of embodiment 13 or 18 wherein sending (1012) the notification of the SGW address change comprises sending (1012) the notification of the SGW address change after the first combined SGW/PGW/SMF (902-1) has failed or otherwise gone offline.

20. The method of any of embodiments 13 to 19 wherein notification of the address change comprises a new SGW address.

21. The method of embodiment 20 wherein the second address of the SGW of the second combined SGW/PGW/SMF (902-2) is an IP address or FQDN.

22. The method of embodiment 20 or 21 wherein the notification of the SGW address change comprises a create/update/delete bearer request comprising one or more PGW Change Info IEs, at least one of which comprises the second address of the SGW of the second combined SGW/PGW/SMF (902-2).

23. The method of embodiment 20 or 21 wherein the notification of the SGW address change comprises a create/update/delete bearer request comprising one or more PGW Change Info IEs, at least one of which comprises an IE that comprises the second address of the SGW of the second combined SGW/PGW/SMF (902-2).

24 The method of any of embodiments 13 to 23 wherein the core network node (906) is an MME (906).

25. A network node (1100) adapted to perform the method of any of embodiments 1 to 24.

### 7.2.3 Create Bearer Request

The direction of this message shall be from PGW to SGW and from SGW to MME/S4-SGSN, and from PGW to TWAN/ePDG (see Table 6.1-1).

The Create Bearer Request message shall be sent on the S5/S8 interface by the PGW to the SGW and on the S11 interface by the SGW to the MME as part of the Dedicated Bearer Activation procedure.

The message shall also be sent on the S5/S8 interface by the PGW to the SGW and on the S4 interface by the SGW to the SGSN as part of the Secondary PDP Context Activation procedure or the Network Requested Secondary PDP Context Activation procedure.

The message shall also be sent on the S2a interface by the PGW to the TWAN as part of the Dedicated bearer activation in WLAN on GTP S2a, and on the S2b interface by the PGW to the ePDG as part of the Dedicated S2b bearer activation with GTP on S2b.

The message shall also be sent on the S5/S8 or S2a/S2b interface by the PGW to the SGW or to the TWAN/ePDG and on the S11/S4 interface by the SGW to the MME/S4-SGSN as part of the Network-initiated IP flow mobility procedure or the UE-initiated IP flow mobility procedure, as specified by 3GPP TS 23.161 [71].

TABLE 7.2.3-1
Information Elements in a Create Bearer Request

| Information elements | P | Condition/Comment | IE Type | Ins. |
|---|---|---|---|---|
| Procedure | C | This IE shall be sent on the S5/S8 and S4/S11 interfaces | PTI | 0 |
| Transaction Id (PTI) | | when the procedure was initiated by a UE Requested | | |
| | | Bearer Resource Modification Procedure or UE Requested | | |
| | | Bearer Resource Allocation Procedure (see NOTE 1) or | | |
| | | Secondary PDP Context Activation Procedure. | | |
| | | The PTI shall be the same as the one used in the | | |
| | | corresponding Bearer Resource Command. | | |
| Linked EPS Bearer ID | M | This IE shall be included to indicate the default bearer | EBI | 0 |
| (LBI) | | associated with the PDN connection. | | |
| Protocol | O | This IE may be sent on the S5/S8 and S4/S11 interfaces if | PCO | 0 |
| Configuration Options | | ePCO is not supported by the UE or the network. | | |
| (PCO) | | | | |
| Bearer Contexts | M | Several IEs with this type and instance values shall be | Bearer Context | 0 |
| | | included as necessary to represent a list of Bearers. | | |
| PGW-FQ-CSID | C | This IE shall be included by the PGW on the S5/S8 and | FQ-CSID | 0 |
| | | S2a/S2b interfaces and, when received from S5/S8 be | | |
| | | forwarded by the SGW on the S11 interface according to | | |
| | | the requirements in 3GPP TS 23.007 [17]. | | |
| SGW-FQ-CSID | C | This IE shall be included by the SGW on the S11 interface | FQ-CSID | 1 |
| | | according to the requirements in 3GPP TS 23.007 [17]. | | |
| Change Reporting | C | This IE shall be included on the S5/S8 and S4/S11 | Change Reporting | 0 |
| Action | | interfaces with the appropriate Action field If the location | Action | |
| | | Change Reporting mechanism is to be started or stopped | | |
| | | for this subscriber in the SGSN/MME. | | |
| CSG Information | CO | This IE shall be included on the S5/S8 and S4/S11 | CSG Information | 0 |
| Reporting Action | | interfaces with the appropriate Action field if the CSG Info | Reporting Action | |
| | | reporting mechanism is to be started or stopped for this | | |
| | | subscriber in the SGSN/MME. | | |
| H(e)NB Information | CO | This IE shall be included on the S5/S8 and S4/S11 | H(e)NB | 0 |
| Reporting | | interfaces with the appropriate Action field if H(e)NB | Information | |
| | | information reporting is to be started or stopped for the | Reporting | |
| | | PDN connection in the SGSN/MME. | | |
| Presence Reporting | CO | This IE shall be included on the S5/S8 and S11/S4 | Presence | 0 |
| Area Action | | interfaces with the appropriate Action field if reporting | Reporting Area | |
| | | changes of UE presence in a Presence Routing Area is to | Action | |
| | | be started, stopped or modified for this subscriber in the | | |
| | | MME/SGSN. | | |
| | | Several IEs with the same type and instance value may be | | |
| | | included as necessary to represent a list of Presence | | |
| | | Reporting Area Actions. One IE shall be included per PRA | | |
| | | to be started, stopped or modified. | | |
| Indication Flags | CO | This IE shall be included if any one of the applicable flags | Indication | 0 |
| | | is set to 1. | | |
| | | Applicable flags are: | | |
| | | Associate OCI with PGW node's identity: The | | |
| | | PGW shall set this flag to 1 on the S5/S8 interface | | |
| | | or S2a/S2b interface if it has included the “PGW's | | |
| | | Overload Control Information” and if this | | |
| | | information is to be associated with the node | | |
| | | identity (i.e. FQDN or the IP address received from | | |
| | | the HSS or DNS during the PGW selection) of the | | |
| | | serving PGW. The SGW shall set this flag on the | | |
| | | S11/S4 interface if it supports the overload control | | |
| | | feature and if the flag is set on the S5/S8 interface. | | |
| | | Associate OCI with SGW node's identity: The | | |
| | | SGW shall set this flag to 1 on the S11/S4 | | |
| | | interface if it has included the “SGW's Overload | | |
| | | Control Information” and if this information is to be | | |
| | | associated with the node identity (i.e. FQDN or the | | |
| | | IP address received from the DNS during the SGW | | |
| | | selection) of the serving SGW. | | |
| | | Extended EBI Value Range Support Indication: | | |
| | | The PGW shall set this flag to “1” if it supports the | | |
| | | 15 EPS Bearers. | | |
| PGW's node level | O | The PGW may include this IE on the S5/S8 or S2a/S2b | Load Control | 0 |
| Load Control | | interface, providing its node level load information, if the | Information | |
| Information | | load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access network, belongs (see | | |
| | | clause 12.2.6). | | |
| | CO | If the SGW receives this IE and if it supports the load | | |
| | | control feature, it shall forward it to the MME/S4-SGSN on | | |
| | | the S11/S4 interface. | | |
| PGW's APN level | O | The PGW may include this IE on the S5/S8 or S2a/S2b | Load Control | 1 |
| Load Control | | interface, providing APN level load information, if the APN | Information | |
| Information | | level load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access based network, | | |
| | | belongs (see clause 12.2.6). | | |
| | | When present, the PGW shall provide one or more | | |
| | | instances of this IE, up to maximum of 10, with the same | | |
| | | type and instance value, each representing the load | | |
| | | information for a list of APN(s). | | |
| | | See NOTE 2, NOTE 4. | | |
| | CO | If the SGW receives this IE and if it supports APN level | | |
| | | load control feature, it shall forward it to the MME/S4- | | |
| | | SGSN on the S11/S4 interface. | | |
| SGW's node level | O | The SGW may include this IE, over the S11/S4 interface if | Load Control | 2 |
| Load Control | | the load control feature is supported by the SGW and is | Information | |
| Information | | activated in the network (see clause 12.2.6). | | |
| | | When present, the SGW shall provide only one instance of | | |
| | | this IE, representing its node level load information. | | |
| PGW's Overload | O | During an overload condition, the PGW may include this IE | Overload Control | 0 |
| Control Information | | on the S5/S8 or S2a/S2b interface, if the overload control | Information | |
| | | feature is supported by the PGW and is activated for the | | |
| | | PLMN to which the access network node, i.e. MME/S4- | | |
| | | SGSN for 3GPP access based network, ePDG/TWAN for | | |
| | | non-3GPP access based network, belongs (see clause | | |
| | | 12.3.11). | | |
| | | When present, the PGW shall provide | | |
| | | node level overload control, in one instance of this | | |
| | | IE; and/or | | |
| | | APN level overload control, in one or more | | |
| | | instances of this IE, up to maximum of 10, with the | | |
| | | same type and instance value, each representing | | |
| | | the overload information for a list of APN(s). | | |
| | | See NOTE 3, NOTE 5. | | |
| | CO | If the SGW receives this IE and if it supports the overload | | |
| | | control feature, it shall forward it to the MME/S4-SGSN on | | |
| | | the S11/S4 interface. | | |
| SGW's Overload | O | During an overload condition, the SGW may include this IE | Overload Control | 1 |
| Control Information | | over the S11/S4 interface if the overload control feature is | Information | |
| | | supported by the SGW and is activated in the network (see | | |
| | | clause 12.3.11). | | |
| | | When present, the SGW shall provide only one instance of | | |
| | | this IE, representing its overload information. | | |
| NBIFOM Container | CO | This IE shall be included on the S5/S8 and S2a/S2b | F-Container | 0 |
| | | interfaces if the PGW needs to send NBIFOM information | | |
| | | as specified in 3GPP TS 23.161 [71]. The Container Type | | |
| | | shall be set to 4. | | |
| | CO | If the SGW receives a NBIFOM Container IE from the | | |
| | | PGW, the SGW shall forward it to the MME/S4-SGSN on | | |
| | | the S11/S4 interface. | | |
| PGW Change Info | CO | This IE may be included on S5/S8 if the PGW needs to | PGW Change Info | 0 |
| | | change the PGW Change Info. It shall be included by the | | |
| | | PGW if the PGW S5/S8 IP Address for the control plane | | |
| | | for the PDN connection is required to be changed (see | | |
| | | PGW triggered PDN connection restoration in clause 31.4 | | |
| | | of 3GPP TS 23.007 [17]). | | |
| | | The SGW shall transparently forward this IE over the S11 | | |
| | | interface. | | |
| | | Several IEs with the same IE type and Instance may be | | |
| | | present to request the MME to re-establish PDN | | |
| | | connections associated with either different FQ-CSIDs, or | | |
| | | Group Ids or PGW-C/SMF IP addresses to different PGW- | | |
| | | C/SMFs. | | |
| Private Extension | O | This IE may be sent on the S5/S8, S4/S11 and S2a/S2b | Private Extension | VS |
| | | interfaces. | | |

NOTE 1:
This message refers to the UE requested bearer resource allocation procedure and UE requested bearer resource modification procedures defined in 3GPP TS 24.301 [23], both are specified in 3GPP TS 23.401 [3] in the clause “UE requested bearer resource modification”.
NOTE 2:
The receiver, not supporting the APN level load control feature, shall ignore all the occurrence(s) of this IE, i.e. “Load Control Information” IE with instance number “1”. The receiver, supporting the APN level load control feature and supporting the APN level load information for the maximum of 10 APNs, shall handle the APN level load information for the first 10 APNs and ignore any more APN level load information.
NOTE 3:
The receiver, supporting the APN level overload information for the maximum of 10 APNs, shall handle the APN level overload information for the first 10 APNs and ignore any more APN level overload information.
NOTE 4:
The APN level load information, provided within and across different instances of the “PGW's APN level Load Control Information” IE(s) shall be limited to 10 different APNs.
NOTE 5:
The APN level overload information, provided within and across different instances of the “PGW's Overload Control Information” IE(s) shall be limited to 10 different APNs.
NOTE:
In the case that the procedure was initiated by a UE Requested Bearer Resource Modification Procedure or a UE Requested Bearer Resource Allocation Procedure or Secondary PDP Context Activation Procedure, then there will be only one instance of the Bearer Contexts IE in the Create Bearer Request.

TABLE 7.2.3-2
Bearer Context within Create Bearer Request
Octets 1 Bearer Context IE Type = 93 (decimal)
Octets 2 and 3 Length = n
Octets 4 Spare and Instance fields

| Information elements | P | Condition/Comment | IE Type | Ins. |
|---|---|---|---|---|
| EPS Bearer ID | M | This IE shall be set to 0. | EBI | 0 |
| TFT | M | This IE can contain both uplink and downlink packet filters | Bearer TFT | 0 |
| | | to be sent to the UE or the TWAN/ePDG. | | |
| S1-U SGW F-TEID | C | This IE shall be sent on the S11 interface if the S1-U | F-TEID | 0 |
| | | interface is used. | | |
| | | If SGW supports both IPv4 and IPv6, it shall send both an | | |
| | | IPv4 address and an IPv6 address within the S1-U SGW | | |
| | | F-TEID IE. | | |
| | | See NOTE 1. | | |
| S5/8-U PGW F-TEID | C | This IE shall be sent on the S4, S5/S8 and S11 interfaces | F-TEID | 1 |
| | | for GTP-based S5/S8 interface. The MME/SGSN shall | | |
| | | ignore the IE on S11/S4 for PMIP-based S5/S8 interface. | | |
| S12 SGW F-TEID | C | This IE shall be sent on the S4 interface if the S12 | F-TEID | 2 |
| | | interface is used. See NOTE 1. | | |
| S4-U SGW F-TEID | C | This IE shall be sent on the S4 interface if the S4-U | F-TEID | 3 |
| | | interface is used. See NOTE 1. | | |
| S2b-U PGW F-TEID | C | This IE (for user plane) shall be sent on the S2b interface. | F-TEID | 4 |
| S2a-U PGW F-TEID | C | This IE (for user plane) shall be sent on the S2a interface. | F-TEID | 5 |
| Bearer Level QoS | M | | Bearer QoS | 0 |
| Charging Id | C | This IE shall be sent on the S5/S8 interface. | Charging Id | 0 |
| | O | If the S5/S8 interface is GTP, this IE may be sent on the | | |
| | | S4 interface, in order to support CAMEL charging at the | | |
| | | SGSN. | | |
| | CO | This IE shall be sent on the S2a/S2b interface. | | |
| Bearer Flags | O | Applicable flags are: | Bearer Flags | 0 |
| | | PPC (Prohibit Payload Compression): this flag | | |
| | | may be set on the S5/S8 and S4 interfaces. | | |
| | | vSRVCC indicator: This IE may be included by the | | |
| | | PGW on the S5/S8 interface according to 3GPP | | |
| | | TS 23.216 [43]. When received from S5/S8, SGW | | |
| | | shall forward on the S11 interface. | | |
| Protocol | O | This IE may be sent on the S5/S8 and S4/S11 interfaces if | PCO | 0 |
| Configuration Options | | ePCO is not supported by the UE or the network. This | | |
| (PCO) | | bearer level IE takes precedence over the PCO IE in the | | |
| | | message body if they both exist. | | |
| Extended Protocol | O | This IE may be sent on the S5/S8 and S11 interfaces if the | ePCO | 0 |
| Configuration Options | | UE and the network support ePCO. | | |
| (ePCO) | | | | |
| Maximum Packet | O | This IE may be included on the S5/S8 interfaces if the | Maximum Packet | 0 |
| Loss Rate | | PGW needs to send Maximum Packet Loss Rate as | Loss Rate | |
| | | specified in clause 5.4.1 of 3GPP TS 23.401 [3]. This IE is | | |
| | | only applicable for QCI 1. | | |
| | CO | If the SGW receives this IE, it shall forward it to the MME | | |
| | | on the S11 interface | | |

NOTE 1:
The SGW shall use the same F-TEID IP address and TEID values for S1-U, S4-U and S12 interfaces.

TABLE 7.2.3-3
Load Control Information within Create Bearer Request
Octet 1 Load Control Information IE Type = 181 (decimal)
Octets 2 and 3 Length = n
Octet 4 Spare and Instance fields

| Information | | | | |
|---|---|---|---|---|
| elements | P | Condition/Comment | IE Type | Ins. |
| Load Control | M | See clause 12.2.5.1.2.1 for the description and use of this | Sequence | 0 |
| Sequence Number | | parameter. | Number | |
| Load Metric | M | See clauses 12.2.5.1.2.2 and 12.2.5.1.2.3 for the | Metric | 0 |
| | | description and use of this parameter. | | |
| List of APN and | CO | The IE shall (only) be present in the “PGW's APN level | APN and Relative | 0 |
| Relative Capacity | | Load Control Information” IE. | Capacity | |
| | | For indicating the APN level load, the PGW shall include | | |
| | | one or more instances of this IE, up to maximum of 10, | | |
| | | with the same type and instance value, representing a list | | |
| | | of APN(s) & its respective “Relative Capacity” (sharing the | | |
| | | same “Load Metric”). | | |
| | | See clause 12.2.5.1.2.3 for the description and use of this | | |
| | | parameter. | | |
| | | See NOTE 1. | | |

NOTE 1:
If more than 10 occurrences of “APN and Relative Capacity” IE are received within one instance of the Load Control Information IE, the receiver shall treat it as a protocol error and ignore the entire Load Control Information IE instance.

TABLE 7.2.3-4
Overload Control Information within Create Bearer Request
Octet 1 Overload Control Information IE Type = 181 (decimal)
Octets 2 and 3 Length = n
Octet 4 Spare and Instance fields

| Information elements | P | Condition/Comment | IE Type | Ins. |
|---|---|---|---|---|
| Overload Control | M | See clause 12.3.5.1.2.1 for the description and use of this | Sequence | 0 |
| Sequence Number | | parameter. | Number | |
| Overload Reduction | M | See clauses 12.3.5.1.2.3 and 12.3.5.1.2.4 for the | Metric | 0 |
| Metric | | description and use of this parameter. | | |
| Period of Validity | M | See clause 12.3.5.1.2.2 for the description and use of this | EPC Timer | 0 |
| | | parameter. | | |
| | | This IE should be set to “0” if the “Overload Reduction | | |
| | | Metric” is null. This IE shall be ignored by the receiver if the | | |
| | | “Overload Reduction Metric” is null. | | |
| List of Access Point | CO | The IE may (only) be present in the “PGW's Overload | APN | 0 |
| Name (APN) | | Control Information” IE. | | |
| | | For indicating the APN level overload, the PGW shall | | |
| | | include one or more instances of this IE, up to maximum of | | |
| | | 10, with the same type and instance value, representing a | | |
| | | list of APN(s) (sharing the same “Overload Reduction | | |
| | | Metric” and “Period of Validity”). | | |
| | | See NOTE 1. | | |

NOTE 1:
If more than 10 occurrences of APNs are received within one instance of the Overload Control Information IE, the receiver shall treat it as a protocol error and ignore the entire Overload Control Information IE instance.

TABLE 7.2.3-5
PGW Change Info within Create Bearer Request
Octet 1 PGW Change Info IE Type = 214 (decimal)
Octets 2 and 3 Length = n
Octet 4 Spare and Instance fields

| Information elements | P | Condition/Comment | IE Type | Ins. |
|---|---|---|---|---|
| PGW Set FQDN | O | This IE may be included by a PGW if the PGW set FQDN | PGW Set FQDN | 0 |
| | | is changed. | | |
| Alternative PGW- | O | This IE may be included by a PGW if the list of alternative | IP Address | 0 |
| C/SMF IP Address | | PGW-C/SMF IP addresses is changed. | | |
| | | Several IEs with the same type and instance value may be | | |
| | | included to represent a list of Alternative PGW-C/SMF IP | | |
| | | Addresses. | | |
| New PGW-C/SMF IP | C | This IE shall be included by a PGW if the PGW S5/S8 IP | IP Address | 1 |
| Address | | Address for the control plane for the PDN connection is | | |
| | | required to be changed (see PGW triggered PDN | | |
| | | connection restoration in clause 31.4 of of | | |
| | | 3GPP TS 23.007 [17]). | | |
| New SGW-C IP | O | This IE may be included by a combined SGW/PGW to | IP Address | 3 |
| Address | | contain the SGW S11 IP address which the MME should | | |
| | | send the Create Session Request message towards. | | |
| | | during a MME triggered PDN connection restoration | | |
| | | procedure, as specified in clause 31.3 of of | | |
| | | 3GPP TS 23.007 [17]. | | |
| PGW-C/SMF FQ-CSID | C | This IE shall be included if the New PGW-C/SMF IP | FQ-CSID | 0 |
| | | Address IE is present and if the PGW-C/SMF requests the | | |
| | | MME to re-establish all the PDN connections associated | | |
| | | with a PGW-C/SMF FQ-CSID towards the PGW-C | | |
| | | indicated in New PGW-C/SMF IP Address IE. | | |
| | | When present, it shall contain the PGW-C/SMF FQ-CSID | | |
| | | for which the PDN connections are requested to be re- | | |
| | | established. | | |
| | | Several IEs with the same IE type may be present to | | |
| | | represent several FQ-CSIDsof PDN connections that need | | |
| | | to be moved to the New PGW-C/SMF IP Address. | | |
| | | See also clause 31.x of 3GPP TS 23.007 [17]. | | |
| Group Id | C | This IE shall be included if the New PGW-C/SMF IP | Group Id | 0 |
| | | Address IE is present and if the PGW-C/SMF requests the | | |
| | | MME to re-establish all the PDN connections associated | | |
| | | with a Group Id towards the PGW-C indicated in New | | |
| | | PGW-C/SMF IP Address IE. | | |
| | | When present, it shall contain the Group Id for which the | | |
| | | PDN connections are requested to be re-established. | | |
| | | Several IEs with the same IE type may be present to | | |
| | | represent several Group Ids of PDN connections that need | | |
| | | to be moved to the New PGW-C/SMF IP Address. | | |
| | | See also clause 31.x of 3GPP TS 23.007 [17]. | | |
| PGW Control Plane IP | C | This IE shall be included if the New PGW-C/SMF IP | IP Address | 2 |
| Address | | Address IE is present and if the PGW-C/SMF requests the | | |
| | | MME to re-establish all the PDN connections of which | | |
| | | PGW S5/S8/ S2a/S2b F-TEID contains the PGW Control | | |
| | | Plane IP Address towards the PGW-C indicated in New | | |
| | | PGW-C/SMF IP Address IE. | | |
| | | Several IEs with the same IE type may be present to | | |
| | | represent several PGW-C/SMF IP addresses of PDN | | |
| | | connections that need to be moved to the New PGW- | | |
| | | C/SMF IP Address. | | |
| | | See also clause 31.x of 3GPP TS 23.007 [17]. | | |
| New Group Id | O | The IE may be present if the PGW-C/SMF wants to | Group Id | 1 |
| | | allocate a new Group Id for the PDN connection. When | | |
| | | present, this IE shall identify the new Group Id to which the | | |
| | | PDN connection pertains, and the MME shall replace any | | |
| | | earlier Group ID received for the PDN connection with the | | |
| | | new Group ID. If absent, the Group ID associated earlier to | | |
| | | the PDN connection, if any, shall remain unchanged. | | |
| | | See also clause 31.x of 3GPP TS 23.007 [17]. | | |

### 7.2.9.2 Delete Bearer Request

The direction of this message shall be from PGW to SGW, from SGW to MME/S4-SGSN and from PGW to TWAN/ePDG (see Table 6.1-1).

A Delete Bearer Request message shall be sent on the S5/S8 and S4/S11 interfaces as part of the following procedures:
PGW or MME initiated bearer deactivation procedures.
UE requested Bearer Resource Modification,
MS and SGSN Initiated Bearer Deactivation procedure using S4 or
PGW initiated bearer deactivation procedure using S4.

In the above cases, this Request is sent by the PGW to the SGW and shall be forwarded to the MME or S4-SGSN.

The message shall also be sent on the S4/S11 interface by the SGW to the SGSN/MME to delete the bearer resources on the other ISR associated CN node if the ISRAI flag is not set in the Modify Bearer Request/Modify Access Bearers Request message.

The message shall also be sent on the S4/S11 interface by the SGW to the SGSN/MME to delete the bearer resources on the other ISR associated CN node in the TAU/RAU/Handover procedures if the ISR related Cause IE is included in the Delete Session Request message.

The message shall also be sent on the S2b interface by the PGW to the ePDG as part of PGW Initiated Bearer Resource Allocation Deactivation procedure with GTP on S2b.

The message shall also be sent on the S2a interface by the PGW to the TWAN as part of the PGW Initiated Bearer Resource Allocation Deactivation in WLAN on GTP on S2a procedure.

The message may also be sent on the S11/S4 interface by the SGW to the MME/S4 SGSN when the SGW receives the Error Indication from PGW for the default bearer or the ICMP message from a PGW that indicates the UE specific error indication as specified in 3GPP TS 23.007 [17].

The message shall also be sent on the S5/S8 or S2a/S2b interface by the PGW to the SGW or to the TWAN/ePDG and on the S11/S4 interface by the SGW to the MME/S4-SGSN as part of the Network-initiated IP flow mobility procedure, as specified by 3GPP TS 23.161 [71].

The message shall also be sent on the S5/S8 interface by the PGW to the SGW, as part of EPS to 5GS mobility without N26 interface, ePDG/EPC to 5GS handover, EPS to 5GC/N3IWF handover, as specified in 3GPP TS 23.502 [83].

If the UE uses NB-IoT, WB-EUTRAN or GERAN Extended Coverage with increased NAS transmission delay (see 3GPP TS 24.301 and 3GPP TS 24.008 [5]), the MME/SGSN should proceed as specified for a UE in ECM-IDLE state with extended idle mode DRX enabled in clause 5.4.4.1 of 3GPP TS 23.401 [3].

Possible Cause values are:
“RAT changed from 3GPP to Non-3GPP”,
“ISR deactivation”,
“Access changed from Non-3GPP to 3GPP”,
“Reactivation requested”,
“PDN reconnection to this APN disallowed”,
“PDN connection inactivity timer expires”,
“Local release”,
“Multiple accesses to a PDN connection not allowed”,
“EPS to 5GS Mobility”.

Table 7.2.9.2-1 specifies the presence of IEs in this message.

TABLE 7.2.9.2-1
Information Elements in a Delete Bearer Request

| Information elements | P | Condition/Comment | IE Type | Ins. |
|---|---|---|---|---|
| Linked EPS Bearer ID | C | If the request corresponds to the bearer deactivation | EBI | 0 |
| (LBI) | | procedure in case all bearers belonging to a PDN | | |
| | | connection shall be released, then this IE shall be included | | |
| | | on the S5/S8, S4/S11 and S2a/S2b interfaces to indicate | | |
| | | the default bearer associated with the PDN being | | |
| | | disconnected. | | |
| | | This IE shall be included only when the EPS Bearer ID is | | |
| | | not present in the message. | | |
| | CO | During a TAU/RAU/HO if the Cause value is set to “ISR | | |
| | | deactivation” in the Delete Session Request message, or | | |
| | | when this message is used to delete the bearer resources | | |
| | | on the other ISR associated CN node if the ISRAI flag is | | |
| | | not set in the Modify Bearer Request/Modify Access | | |
| | | Bearers Request message, an SGW shall send all LBIs for | | |
| | | a given UE with the message on S4/S11 interface. All LBI | | |
| | | IEs shall have the same type and instance value to | | |
| | | represent a list of IEs (see NOTE 1 and NOTE 2). | | |
| EPS Bearer IDs | C | This IE shall be included on S5/S8, S4/S11 and S2a/S2b | EBI | 1 |
| | | interfaces for deleting bearers different from the default | | |
| | | one, i.e. for dedicated bearers. In this case at least one | | |
| | | dedicated bearer shall be included. | | |
| | | This IE shall be included only when the Linked EPS Bearer | | |
| | | ID is not present in the message. | | |
| | | Several IEs with this type and instance values shall be | | |
| | | included as necessary to represent a list of Bearers. | | |
| Failed Bearer | O | This IE may be included on the S5/S8 and S11 interfaces if | Bearer Context | 0 |
| Contexts | | the request corresponds to MME initiated bearer | | |
| | | deactivation procedure. This IE shall contain the list of | | |
| | | failed bearers if partial Bearer Contexts included in the | | |
| | | Delete Bearer Command message could not be deleted. | | |
| Procedure | C | If the request corresponds to UE requested bearer | PTI | 0 |
| Transaction Id (PTI) | | resource modification procedure for an E-UTRAN, this IE | | |
| | | shall be included on the S5/S8 and S11 interfaces. | | |
| Protocol | C | The PGW shall include Protocol Configuration Options | PCO | 0 |
| Configuration Options | | (PCO) IE on the S5/S8 interface, if available and if ePCO | | |
| (PCO) | | is not supported by the UE or the network. | | |
| | | If SGW receives this IE, SGW shall forward it to | | |
| | | SGSN/MME on the S4/S11 interface. | | |
| | CO | For trusted WLAN access, if the default bearer of the PDN | | |
| | | connection is being deleted and if the multi-connection | | |
| | | mode is used, the PGW may include this IE over the S2a | | |
| | | interface to send PCO to the UE. | | |
| PGW-FQ-CSID | C | This IE shall be included by the PGW on the S5/S8 and | FQ-CSID | 0 |
| | | S2a/S2b interfaces, and when received from S5/S8 be | | |
| | | forwarded by the SGW on the S11 interface according to | | |
| | | the requirements in 3GPP TS 23.007 [17]. | | |
| SGW-FQ-CSID | C | This IE shall be included by the SGW on the S11 interface | FQ-CSID | 1 |
| | | according to the requirements in 3GPP TS 23.007 [17]. | | |
| Cause | C | This IE shall be sent on S5/S8 and S11/S4 interfaces if the | Cause | 0 |
| | | message is caused by a handover with or without | | |
| | | optimization from 3GPP to non-3GPP (see clause 9.3.2 in | | |
| | | 3GPP TS 23.402 [45] and clause 5.4.4.1 in 3GPP TS | | |
| | | 23.401 [3], respectively). In this case the Cause value shall | | |
| | | be set to “RAT changed from 3GPP to Non-3GPP”. | | |
| | | This IE shall also be sent on S11/S4 interfaces when the | | |
| | | SGW requests to delete all bearer contexts for the given | | |
| | | UE in an MME or S4-SGSN due to ISR deactivation, and | | |
| | | the Cause value shall be set to “ISR deactivation”. | | |
| | | This IE shall be sent on the S2a/S2b interface if the | | |
| | | message is caused by handover from non-3GPP to 3GPP. | | |
| | | In this case the Cause value shall be set to “Access | | |
| | | changed from Non-3GPP to 3GPP”. | | |
| | CO | This IE shall be sent on the S5/S8 interface if the message | | |
| | | is caused by EPS to 5GS mobility. In this case the Cause | | |
| | | value shall be set to “EPS to 5GS Mobility”. | | |
| | O | This IE may be sent by a PGW on S5/S8 during PGW | | |
| | | initiated bearer deactivation procedures for the default | | |
| | | bearer with values of “Reactivation requested” or “ PDN | | |
| | | reconnection to this APN disallowed” or “Multiple accesses | | |
| | | to a PDN connection not allowed” (see clause 8.4 for | | |
| | | details). | | |
| | O | This IE may be sent by a PGW on S5 during PGW initiated | | |
| | | bearer deactivation procedures for the default bearer with | | |
| | | values of “PDN connection inactivity timer expires” (see | | |
| | | clause 8.4 for details). | | |
| | CO | The IE shall be relayed by the SGW to the MME/S4-SGSN | | |
| | | if received from the PGW. | | |
| | CO | This IE shall be sent by the PGW on S5/S8 or S2a/S2b | | |
| | | with the value “Reactivation requested”, when the PGW | | |
| | | initiates the bearer deactivation procedure for the default | | |
| | | bearer as part of the P-CSCF restoration procedure over | | |
| | | 3GPP access or WLAN access, as specified in 3GPP TS | | |
| | | 23.380 [61]. | | |
| | CO | This IE shall be sent by the PGW on S5/S8 or S2a/S2b | | |
| | | with the value “Local release”, when the PGW initiates the | | |
| | | bearer deactivation procedure, for the default bearer of the | | |
| | | PDN connection, with local bearer release over one of the | | |
| | | accesses associated with the NB-IFOM connection. This | | |
| | | can be triggered, for example, as part of the P-CSCF | | |
| | | restoration procedure specified in 3GPP TS 23.380 [61], or | | |
| | | upon receipt by the PGW of a Delete Session Request | | |
| | | from an MME/SGSN with the ROAA Indication set to 1. | | |
| | | See NOTE 3. | | |
| Indication Flags | CO | This IE shall be included if any one of the applicable flags | Indication | 0 |
| | | is set to 1. | | |
| | | Applicable flags are: | | |
| | | Associate OCI with PGW node's identity: The | | |
| | | PGW shall set this flag to 1 on the S5/S8 interface | | |
| | | or S2a/S2b interface if it has included the “PGW's | | |
| | | Overload Control Information” and if this | | |
| | | information is to be associated with the node | | |
| | | identity (i.e. FQDN or the IP address received from | | |
| | | the HSS or DNS during the PGW selection) of the | | |
| | | serving PGW. The SGW shall set this flag on the | | |
| | | S11/S4 interface if it supports the overload control | | |
| | | feature and if the flag is set on the S5/S8 interface. | | |
| | | Associate OCI with SGW node's identity: The | | |
| | | SGW shall set this flag to 1 on the S11/S4 | | |
| | | interface if it has included the “SGW's Overload | | |
| | | Control Information” and if this information is to be | | |
| | | associated with the node identity (i.e. FQDN or the | | |
| | | IP address received from the DNS during the SGW | | |
| | | selection) of the serving SGW. | | |
| PGW's node level | O | The PGW may include this IE on the S5/S8 or S2a/S2b | Load Control | 0 |
| Load Control | | interface, providing its node level load information, if the | Information | |
| Information | | load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access network, belongs (see | | |
| | | clause 12.2.6). | | |
| | CO | If the SGW receives this IE and if it supports the load | | |
| | | control feature, it shall forward it to the MME/S4-SGSN on | | |
| | | the S11/S4 interface. | | |
| PGW's APN level | O | The PGW may include this IE on the S5/S8 or S2a/S2b | Load Control | 1 |
| Load Control | | interface, providing APN level load information, if the APN | Information | |
| Information | | level load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access based network, | | |
| | | belongs (see clause 12.2.6). | | |
| | | When present, the PGW shall provide one or more | | |
| | | instances of this IE, up to maximum of 10, with the same | | |
| | | type and instance value, each representing the load | | |
| | | information for a list of APN(s). | | |
| | | See NOTE 3, NOTE 5. | | |
| | CO | If the SGW receives this IE and if it supports APN level | | |
| | | load control feature, it shall forward it to the MME/S4- | | |
| | | SGSN on the S11/S4 interface. | | |
| SGW's node level | O | The SGW may include this IE, over the S11/S4 interface if | Load Control | 2 |
| Load Control | | the load control feature is supported by the SGW and is | Information | |
| Information | | activated in the network (see clause 12.2.6). | | |
| | | When present, the SGW shall provide only one instance of | | |
| | | this IE, representing its node level load information. | | |
| PGW's Overload | O | During an overload condition, the PGW may include this IE | Overload Control | 0 |
| Control Information | | on the S5/S8 or S2a/S2b interface, if the overload control | Information | |
| | | feature is supported by the PGW and is activated for the | | |
| | | PLMN to which the access network node, i.e. MME/S4- | | |
| | | SGSN for 3GPP access based network, ePDG/TWAN for | | |
| | | non-3GPP access based network, belongs (see clause | | |
| | | 12.3.11). | | |
| | | When present, the PGW shall provide | | |
| | | node level overload control, in one instance of this | | |
| | | IE; and/or | | |
| | | APN level overload control, in one or more | | |
| | | instances of this IE, up to maximum of 10, with the | | |
| | | same type and instance value, each representing | | |
| | | the overload information for a list of APN(s). | | |
| | | See NOTE 4, NOTE 6. | | |
| | CO | If the SGW receives this IE and if it supports the overload | | |
| | | control feature, it shall forward it to the MME/S4-SGSN on | | |
| | | the S11/S4 interface. | | |
| SGW's Overload | O | During an overload condition, the SGW may include this IE | Overload Control | 1 |
| Control Information | | over the S11/S4 interface if the overload control feature is | Information | |
| | | supported by the SGW and is activated in the network (see | | |
| | | clause 12.3.11). | | |
| | | When present, the SGW shall provide only one instance of | | |
| | | this IE, representing its overload information. | | |
| NBIFOM Container | CO | This IE shall be included on the S5/S8 and S2a/S2b | F-Container | 0 0 |
| | | interfaces if the PGW needs to send NBIFOM information | | |
| | | as specified in 3GPP TS 23.161 [71]. The Container Type | | |
| | | shall be set to 4. | | |
| | CO | If the SGW receives a NBIFOM Container IE from the | | |
| | | PGW, the SGW shall forward it to the MME/S4-SGSN on | | |
| | | the S11/S4 interface. | | |
| APN RATE Control | CO | If APN RATE Control Status is available in PGW and the | APN RATE | 0 |
| Status | | delete bearer request is for the default Bearer, APN RATE | Control Status | |
| | | Control Status shall be transfered on the S5/S8 interface. | | |
| | | The SGW shall include the APN RATE Control Status IE | | |
| | | on the S11/S4 interface, if received from the PGW. | | |
| Extended Protocol | CO | The PGW shall include Extended Protocol Configuration | ePCO | 0 |
| Configuration Options | | Options (ePCO) IE on the S5/S8 interface, if available and | | |
| (ePCO) | | if the UE and the network support ePCO. | | |
| | | If the SGW receives this IE, the SGW shall forward it to the | | |
| | | MME on the S11 interface. | | |
| PGW Change Info | CO | This IE may be included on S5/S8 if the PGW needs to | PGW Change Info | 0 |
| | | change the PGW Change Info. It shall be included by the | | |
| | | PGW if the PGW S5/S8 IP Address for the control plane | | |
| | | for the PDN connection is required to be changed (see | | |
| | | PGW triggered PDN connection restoration in clause 31.4 | | |
| | | of of 3GPP TS 23.007 [17]). | | |
| | | The SGW shall transparently forward this IE over the S11 | | |
| | | interface. | | |
| | | Several IEs with the same IE type and Instance may be | | |
| | | present to request the MME to re-establish PDN | | |
| | | connections associated with different either FQ-CSIDs, or | | |
| | | Group Ids or PGW-C/SMF IP addresses to different PGW- | | |
| | | C/SMFs. | | |
| Private Extension | O | This IE may be sent on the S5/S8, S4/S11 and S2a/S2b | Private Extension | VS |
| | | interfaces. | | |

NOTE 1:
If the SGW has sent multiple LBIs to MME/SGSN, but have received only one LBI within the Delete Bearer Response message, this indicates that the MME/SGSN is pre Rel-10. In such case, the SGW shall send separate individual Delete Bearer Request message(s) for each of remaining LBIs.
NOTE 2:
If the SGW has received Delete Session Request with Cause value set to “ISR deactivation” and has subsequently sent a Delete Bearer Request to the MME/SGSN with Cause value set to “ISR deactivation”, then the MME/SGSN shall delete all PDN connections corresponding to all of the LBIs received in the Delete Bearer Request message for this UE. The MME/SGSN shall ignore any LBIs for which there are no matching PDN connections corresponding to these LBIs.
NOTE 3:
Upon receiving a Delete Bearer Request message for the default bearer of the PDN connection with cause “Local release”, the MME/SGSN or TWAN/ePDG shall behave as specified in clause 5.7.3 of the 3GPP TS 23.380 [61].
NOTE:
In the case that the procedure was initiated by a UE Requested Bearer Resource Modification Procedure for an E-UTRAN as specified by 3GPP TS 24.301 [23], then there will be only one instance of the EPS Bearer IDs IE in the Delete Bearer Request.

TABLE 7.2.9.2-2
Bearer Context within Delete Bearer Request
Octet 1 Bearer Context IE Type = 93 (decimal)
Octets 2 and 3 Length = n
Octet 4 Spare and Instance fields

| Information | | | | |
|---|---|---|---|---|
| elements | P | Condition/Comment | IE Type | Ins. |
| EPS Bearer ID | M | | EBI | 0 |
| Cause | M | This IE shall indicate the reason of | Cause | 0 |
| | | the unsuccessful handling of the | | |
| | | bearer. | | |

TABLE 7.2.9.2-3
Load Control Information within Delete Bearer Request
Octet 1 Load Control Information IE Type = 181 (decimal)
Octets 2 and 3 Length = n
Octet 4 Spare and Instance fields

| Information | | | | |
|---|---|---|---|---|
| elements | P | Condition/Comment | IE Type | Ins. |
| Load Control | M | See clause 12.2.5.1.2.1 for the description and use of this | Sequence | 0 |
| Sequence Number | | parameter. | Number | |
| Load Metric | M | See clauses 12.2.5.1.2.2 and 12.2.5.1.2.3 for the | Metric | 0 |
| | | description and use of this parameter. | | |
| List of APN and | CO | The IE shall (only) be present in the “PGW's APN level | APN and Relative | 0 |
| Relative Capacity | | Load Control Information” IE. | Capacity | |
| | | For indicating the APN level load, the PGW shall include | | |
| | | one or more instances of this IE, up to maximum of 10, | | |
| | | with the same type and instance value, representing a list | | |
| | | of APN(s) & its respective “Relative Capacity” (sharing the | | |
| | | same “Load Metric”). | | |
| | | See clause 12.2.5.1.2.3 for the description and use of this | | |
| | | parameter. | | |
| | | See NOTE 1. | | |

NOTE 1:
If more than 10 occurrences of “APN and Relative Capacity” IE are received within one instance of the Load Control Information IE, the receiver shall treat it as a protocol error and ignore the entire Load Control Information IE instance.

TABLE 7.2.9.2-4
Overload Control Information within Delete Bearer Request
Octet 1 Overload Control Information IE Type = 180 (decimal)
Octets 2 and 3 Length = n
Octet 4 Spare and Instance fields

| Information elements | P | Condition/Comment | IE Type | Ins. |
|---|---|---|---|---|
| Overload Control | M | See clause 12.3.5.1.2.1 for the description and use of this | Sequence | 0 |
| Sequence Number | | parameter. | Number | |
| Overload Reduction | M | See clauses 12.3.5.1.2.3 and 12.3.5.1.2.4 for the | Metric | 0 |
| Metric | | description and use of this parameter. | | |
| Period of Validity | M | See clause 12.3.5.1.2.2 for the description and use of this | EPC Timer | 0 |
| | | parameter. | | |
| | | This IE should be set to “0” if the “Overload Reduction | | |
| | | Metric” is null. This IE shall be ignored by the receiver if the | | |
| | | “Overload Reduction Metric” is null. | | |
| List of Access Point | CO | The IE may (only) be present in the “PGW's Overload | APN | 0 |
| Name (APN) | | Control Information” IE. | | |
| | | For indicating the APN level overload, the PGW shall | | |
| | | include one or more instances of this IE, up to maximum of | | |
| | | 10, with the same type and instance value, representing a | | |
| | | list of APN(s) (sharing the same “Overload Reduction | | |
| | | Metric” and “Period of Validity”). See NOTE 1. | | |

NOTE 1:
If more than 10 occurrences of APNs are received within one instance of the Overload Control Information IE, the receiver shall treat it as a protocol error and ignore the entire Overload Control Information IE instance.

TABLE 7.2.9.2-5
PGW Set Change within Delete Bearer Request
Octet 1 PGW Change Info IE Type = 214 (decimal)
Octets 2 and 3 Length = n
Octet 4 Spare and Instance fields

| Information elements | P | Condition/Comment | IE Type | Ins. |
|---|---|---|---|---|
| PGW Set FQDN | O | This IE may be included by a PGW if the PGW Set FQDN | PGW Set FQDN | 0 |
| | | is changed. | | |
| Alternative PGW- | O | This IE may be included by a PGW if the list of alternative | IP Address | 0 |
| C/SMF IP Address | | PGW-C/SMF IP addresses is changed. | | |
| | | Several IEs with the same type and instance value may be | | |
| | | included to represent a list of Alternative PGW-C/SMF IP | | |
| | | Addresses. | | |
| New PGW-C/SMF IP | C | This IE shall be included by a PGW if the PGW S5/S8 IP | IP Address | 1 |
| Address | | Address for the control plane for the PDN connection is | | |
| | | required to be changed (see PGW triggered PDN | | |
| | | connection restoration in clause 31.4 of of | | |
| | | 3GPP TS 23.007 [17]). | | |
| New SGW-C IP | O | This IE may be included by a combined SGW/PGW to | IP Address | 3 |
| Address | | contain the SGW S11 IP address which the MME should | | |
| | | send the Create Session Request message towards, | | |
| | | during a MME triggered PDN connection restoration | | |
| | | procedure, as specified in clause 31.3 of of | | |
| | | 3GPP TS 23.007 [17]. | | |
| PGW-C/SMF FQ-CSID | C | This IE shall be included if the New PGW-C/SMF IP | FQ-CSID | 0 |
| | | Address IE is present and if the PGW-C/SMF requests the | | |
| | | MME to re-establish all the PDN connections associated | | |
| | | with a PGW-C/SMF FQ-CSID towards the PGW-C | | |
| | | indicated in New PGW-C/SMF IP Address IE. | | |
| | | When present, it shall contain the PGW-C/SMF FQ-CSID | | |
| | | for which the PDN connections are requested to be re- | | |
| | | established. | | |
| | | Several IEs with the same IE type may be present to | | |
| | | represent several FQ-CSIDsof PDN connections that need | | |
| | | to be moved to the New PGW-C/SMF IP Address. | | |
| | | See also clause 31.x of 3GPP TS 23.007 [17]. | | |
| Group Id | C | This IE shall be included if the New PGW-C/SMF IP | Group Id | 0 |
| | | Address IE is present and if the PGW-C/SMF requests the | | |
| | | MME to re-establish all the PDN connections associated | | |
| | | with a Group Id towards the PGW-C indicated in New | | |
| | | PGW-C/SMF IP Address IE. | | |
| | | When present, it shall contain the Group Id for which the | | |
| | | PDN connections are requested to be re-established. | | |
| | | Several IEs with the same IE type may be present to | | |
| | | represent several Group Ids of PDN connections that need | | |
| | | to be moved to the New PGW-C/SMF IP Address. | | |
| | | See also clause 31.x of 3GPP TS 23.007 [17]. | | |
| PGW Control Plane IP | C | This IE shall be included if the New PGW-C/SMF IP | IP Address | 2 |
| Address | | Address IE is present and if the PGW-C/SMF requests the | | |
| | | MME to re-establish all the PDN connections of which | | |
| | | PGW S5/S8/ S2a/S2b F-TEID contains the PGW Control | | |
| | | Plane IP Address towards the PGW-C indicated in New | | |
| | | PGW-C/SMF IP Address IE. | | |
| | | Several IEs with the same IE type may be present to | | |
| | | represent several PGW-C/SMF IP addresses of PDN | | |
| | | connections that need to be moved to the New PGW- | | |
| | | C/SMF IP Address. | | |
| | | See also clause 31.x of 3GPP TS 23.007 [17]. | | |
| New Group Id | O | The IE may be present if the PGW-C/SMF wants to | Group Id | 1 |
| | | allocate a new Group Id for the PDN connection. When | | |
| | | present, this IE shall identify the new Group Id to which the | | |
| | | PDN connection pertains, and the MME shall replace any | | |
| | | earlier Group ID received for the PDN connection with the | | |
| | | new Group ID. If absent, the Group ID associated earlier to | | |
| | | the PDN connection, if any, shall remain unchanged. | | |
| | | See also clause 31.x of 3GPP TS 23.007 [17]. | | |

### 7.2.15 Update Bearer Request

The direction of this message shall be from PGW to SGW and/or from SGW to MME/S4-SGSN, and/or from PGW to TWAN/ePDG (see Table 6.1-1).

For GTP based S5/S8, the Update Bearer Request shall be sent by the PGW to the SGW and forwarded to the MME as part of the following procedures:
PGW Initiated Bearer Modification with Bearer QoS Update
HSS Initiated Subscribed QoS Modification
PGW Initiated Bearer Modification without Bearer QoS Update
UE Request Bearer Resource Modification procedure (see 3GPP TS 24.301 [23])
UE requested bearer resource allocation procedure (see 3GPP TS 24.301 [23])
P-CSCF restoration for 3GPP access (see 3GPP TS 23.380 [61])

The message shall also be sent on the S5/S8 interface by the PGW to the SGW and on the S4 interface by the SGW to the SGSN as part of the following procedures:
PGW Initiated EPS Bearer Modification
Execution part of MS-Initiated EPS Bearer Modification
SGSN-Initiated EPS Bearer Modification Procedure using S4
P-CSCF restoration for 3GPP access (see 3GPP TS 23.380 [61])

The message shall also be sent on the S2a/S2b interface by the PGW to the TWAN/ePDG as part of the following procedures:
PGW Initiated Bearer Modification
HSS Initiated Subscribed QoS Modification
P-CSCF restoration for WLAN access (see 3GPP TS 23.380 [61])

For PMIP based S5/S8, the Update Bearer Request shall be sent on the S11 interface by the SGW to the MME and on the S4 interface by the SGW to the SGSN.

The message shall also be sent on the S5/S8 or S2a/S2b interface by the PGW to the SGW or to the TWAN/ePDG and on the S11/S4 interface by the SGW to the MME/S4-SGSN as part of the Network-initiated IP flow mobility procedure or the UE-initiated IP flow mobility procedure, as specified by 3GPP TS 23.161 [71].

5 Table 7.2.15-1 specifies the presence requirements and the conditions of the IEs in the message.

TABLE 7.2.15-1
Information Elements in an Update Bearer Request

| Information elements | P | Condition/Comment | IE Type | Ins. |
|---|---|---|---|---|
| Bearer Contexts | M | This IE shall contain contexts related to bearers that need | Bearer Context | 0 |
| | | QoS/TFT modification. Several IEs with this type and | | |
| | | instance values shall be included as necessary to | | |
| | | represent a list of Bearers. | | |
| | | If there is no QoS/TFT modification, only one IE with this | | |
| | | type and instance value shall be included. | | |
| Procedure | C | If the request corresponds to UE requested bearer | PTI | 0 |
| Transaction Id (PTI) | | resource modification procedure or the UE requested | | |
| | | bearer resource allocation procedure for an E-UTRAN (see | | |
| | | NOTE 1) or MS initiated EPS bearer modification | | |
| | | procedure, this IE shall be included. | | |
| | | PTI shall be the same as the one used in the | | |
| | | corresponding Bearer Resource Command | | |
| Protocol | C | The PGW shall include the Protocol Configuration Options | PCO | 0 |
| Configuration Options | | (PCO) IE on the S5/S8 interface, if available and if ePCO | | |
| (PCO) | | is not supported by the UE or the network. The PCO IE | | |
| | | shall carry a P-CSCF address list only when the UE is | | |
| | | required to perform an IMS registration, e.g during the P- | | |
| | | CSCF restoration procedure as defined in clause 5 of | | |
| | | 3GPP TS 23.380 [61]. | | |
| | | If SGW receives this IE, SGW shall forward it to | | |
| | | SGSN/MME on the S4/S11 interface. | | |
| | CO | The PGW shall include the Prococol Configuration Options | | |
| | | (PCO) IE on the S2a interface, including the list of | | |
| | | available P-CSCF addresses, as part of the P-CSCF | | |
| | | restoration extension procedure for the TWAN access, as | | |
| | | specified in 3GPP TS 23.380 [61]. | | |
| Aggregate Maximum | M | APN-AMBR | AMBR | 0 |
| Bit Rate (APN-AMBR) | | | | |
| Change Reporting | C | This IE shall be included on the S5/S8 and S4/S11 | Change Reporting | 0 |
| Action | | interfaces with the appropriate Action field If the location | Action | |
| | | Change Reporting mechanism is to be started or stopped | | |
| | | for this subscriber in the SGSN/MME. | | |
| CSG Information | CO | This IE shall be included on the S5/S8 and S4/S11 | CSG Information | 0 |
| Reporting Action | | interfaces with the appropriate Action field if the CSG Info | Reporting Action | |
| | | reporting mechanism is to be started or stopped for this | | |
| | | subscriber in the SGSN/MME. | | |
| H(e)NB Information | CO | This IE shall be included on the S5/S8 and S4/S11 | H(e)NB | 0 |
| Reporting | | interfaces with the appropriate Action field if H(e)NB | Information | |
| | | information reporting is to be started or stopped for the | Reporting | |
| | | PDN connection in the SGSN/MME. | | |
| Indication flags | CO | This IE shall be included if any one of the applicable flags | Indication | 0 |
| | | is set to 1. | | |
| | | Applicable flags are: | | |
| | | Retrieve Location Indication: This flag shall be set | | |
| | | to 1 on the S5/S8, S4/S11, S2a and S2b interfaces | | |
| | | in the PGW Initiated Bearer Modification procedure | | |
| | | if the location information is requested. | | |
| | | Associate OCI with PGW node's identity: The | | |
| | | PGW shall set this flag to 1 on the S5/S8 interface | | |
| | | or S2a/S2b interface if it has included the “PGW's | | |
| | | Overload Control Information” and if this | | |
| | | information is to be associated with the node | | |
| | | identity (i.e. FQDN or the IP address received from | | |
| | | the HSS or DNS during the PGW selection) of the | | |
| | | serving PGW. The SGW shall set this flag on the | | |
| | | S11/S4 interface if it supports the overload control | | |
| | | feature and if the flag is set on the S5/S8 interface. | | |
| | | Associate OCI with SGW node's identity: The | | |
| | | SGW shall set this flag to 1 on the S11/S4 | | |
| | | interface if it has included the “SGW's Overload | | |
| | | Control Information” and if this information is to be | | |
| | | associated with the node identity (i.e. FQDN or the | | |
| | | IP address received from the DNS during the SGW | | |
| | | selection) of the serving SGW. | | |
| PGW-FQ-CSID | C | This IE shall be included by PGW on the S5/S8 and | FQ-CSID | 0 |
| | | S2a/S2b interfaces, and when received from S5/S8 be | | |
| | | forwarded by SGW on S11 according to the requirements | | |
| | | in 3GPP TS 23.007 [17]. | | |
| SGW-FQ-CSID | C | This IE shall be included by SGW on S11 according to the | FQ-CSID | 1 |
| | | requirements in 3GPP TS 23.007 [17]. | | |
| Presence Reporting | CO | This IE shall be included on the S5/S8 and S11/S4 | Presence | 0 |
| Area Action | | interfaces with the appropriate Action field if reporting | Reporting Area | |
| | | changes of UE presence in Presence Routing Area(s) is to | Action | |
| | | be started, stopped or modified for this subscriber in the | | |
| | | MME/SGSN. | | |
| | | Several IEs with the same type and instance value may be | | |
| | | included as necessary to represent a list of Presence | | |
| | | Reporting Area Actions. One IE shall be included for each | | |
| | | Presence Reporting Area to be started, stopped or | | |
| | | modified. | | |
| PGW's node level | O | The PGW may include this IE on the S5/S8 or S2a/S2b | Load Control | 0 |
| Load Control | | interface, providing its node level load information, if the | Information | |
| Information | | load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access network, belongs (see | | |
| | | clause 12.2.6). | | |
| | CO | If the SGW receives this IE and if it supports the load | | |
| | | control feature, it shall forward it to the MME/S4-SGSN on | | |
| | | the S11/S4 interface. | | |
| PGW's APN level | O | The PGW may include this IE on the S5/S8 or S2a/S2b | Load Control | 1 |
| Load Control | | interface, providing APN level load information, if the APN | Information | |
| Information | | level load control feature is supported by the PGW and is | | |
| | | activated for the PLMN to which the access network node, | | |
| | | i.e. MME/S4-SGSN for 3GPP access network, | | |
| | | ePDG/TWAN for non-3GPP access based network, | | |
| | | belongs (see clause 12.2.6). | | |
| | | When present, the PGW shall provide one or more | | |
| | | instances of this IE, up to maximum of 10, with the same | | |
| | | type and instance value, each representing the load | | |
| | | information for a list of APN(s). | | |
| | | See NOTE 2, NOTE 4. | | |
| | CO | If the SGW receives this IE and if it supports APN level | | |
| | | load control feature, it shall forward it to the MME/S4- | | |
| | | SGSN on the S11/S4 interface. | | |
| SGW's node level | O | The SGW may include this IE, over the S11/S4 interface if | Load Control | 2 |
| Load Control | | the load control feature is supported by the SGW and is | Information | |
| Information | | activated in the network (see clause 12.2.6). | | |
| | | When present, the SGW shall provide only one instance of | | |
| | | this IE, representing its node level load information. | | |
| PGW's Overload | O | During an overload condition, the PGW may include this IE | Overload Control | 0 |
| Control Information | | on the S5/S8 or S2a/S2b interface, if the overload control | Information | |
| | | feature is supported by the PGW and is activated for the | | |
| | | PLMN to which the access network node, i.e. MME/S4- | | |
| | | SGSN for 3GPP access based network, ePDG/TWAN for | | |
| | | non-3GPP access based network, belongs (see clause | | |
| | | 12.3.11). | | |
| | | When present, the PGW shall provide | | |
| | | node level overload control, in one instance of this | | |
| | | IE; and/or | | |
| | | APN level overload control, in one or more | | |
| | | instances of this IE, up to maximum of 10, with the | | |
| | | same type and instance value, each representing | | |
| | | the overload information for a list of APN(s). | | |
| | | See NOTE 3, NOTE 5. | | |
| | CO | If the SGW receives this IE and if it supports the overload | | |
| | | control feature, it shall forward it to the MME/S4-SGSN on | | |
| | | the S11/S4 interface. | | |
| SGW's Overload | O | During an overload condition, the SGW may include this IE | Overload Control | 1 |
| Control Information | | over the S11/S4 interface if the overload control feature is | Information | |
| | | supported by the SGW and is activated in the network (see | | |
| | | clause 12.3.11). | | |
| | | When present, the SGW shall provide only one instance of | | |
| | | this IE, representing its overload information. | | |
| NBIFOM Container | CO | This IE shall be included on the S5/S8 or S2a/S2b | F-Container | 0 |
| | | interfaces if the PGW needs to send NBIFOM information | | |
| | | as specified in 3GPP TS 23.161 [71]. The Container Type | | |
| | | shall be set to 4. | | |
| | CO | If the SGW receives a NBIFOM Container IE from the | | |
| | | PGW, the SGW shall forward it to the MME/S4-SGSN on | | |
| | | the S11/S4 interface. | | |
| PGW Change Info | CO | This IE may be included on S5/S8 if the PGW needs to | PGW Change Info | 0 |
| | | change the PGW Change Info. It shall be included by the | | |
| | | PGW if the PGW S5/S8 IP Address for the control plane | | |
| | | for the PDN connection is required to be changed (see | | |
| | | PGW triggered PDN connection restoration in clause 31.4 | | |
| | | of of 3GPP TS 23.007 [17]). | | |
| | | The SGW shall transparently forward the IE over S11 | | |
| | | interface. | | |
| | | Several IEs with the same IE type and Instance may be | | |
| | | present to request the MME to re-establish PDN | | |
| | | connections associated with different either FQ-CSIDs, or | | |
| | | Group Ids or PGW-C/SMF IP addresses to different PGW- | | |
| | | C/SMFs. | | |
| Private Extension | O | This IE may be sent on the S5/S8, S4/S11 and S2a/S2b | Private Extension | VS |
| | | interfaces. | | |

NOTE 1:
This message refers to the UE requested bearer resource allocation procedure and UE requested bearer resource modification procedures defined in 3GPP TS 24.301 [23], both are specified in 3GPP TS 23.401 in the clause “UE requested bearer resource modification”.
NOTE 2:
The receiver, not supporting the APN level load control feature, shall ignore all the occurrence(s) of this IE, i.e. “Load Control Information” IE with instance number “1”. The receiver, supporting the APN level load control feature and supporting the APN level load information for the maximum of 10 APNs, shall handle the APN level load information for the first 10 APNs and ignore any more APN level load information.
NOTE 3:
The receiver, supporting the APN level overload information for the maximum of 10 APNs, shall handle the APN level overload information for the first 10 APNs and ignore any more APN level overload information.
NOTE 4:
The APN level load information, provided within and across different instances of the “PGW's APN level Load Control Information” IE(s) shall be limited to 10 different APNs.
NOTE 5:
The APN level overload information, provided within and across different instances of the “PGW's Overload Control Information” IE(s) shall be limited to 10 different APNs.
NOTE:
In the case that the procedure was initiated by a UE Requested Bearer Resource Modification Procedure or UE Requested Bearer Resource Allocation Procedure for an E-UTRAN or MS initiated EPS bearer modification procedure, then there will be only one instance of the Bearer Contexts IE in the Update Bearer Request.

TABLE 7.2.15-2
Bearer Context within Update Bearer Request
Octet 1 Bearer Context IE Type = 93 (decimal)
Octets 2 and 3 Length = n
Octet 4 Spare and Instance fields

| Information elements | P | Condition/Comment | IE Type | Ins. |
|---|---|---|---|---|
| EPS Bearer ID | M | | EBI | 0 |
| TFT | C | This IE shall be included on the S5/S8, S4/S11 and | Bearer TFT | 0 |
| | | S2a/S2b interfaces if message relates to Bearer | | |
| | | Modification and TFT change. | | |
| Bearer Level QoS | C | This IE shall be included on the S5/S8, S4/S11 and | Bearer QoS | 0 |
| | | S2a/S2b interfaces if QoS modification is requested | | |
| Bearer Flags | O | Applicable flags: | Bearer Flags | 0 |
| | | PPC (Prohibit Payload Compression): this flag may | | |
| | | be set on the S5/S8 and S4 interfaces. | | |
| | | vSRVCC indicator: This IE may be included by the | | |
| | | PGW on the S5/S8 interface according to 3GPP | | |
| | | TS 23.216 [43]. When received from S5/S8, SGW | | |
| | | shall forward on the S11 interface. | | |
| Protocol | CO | PGW shall include Protocol Configuration Options (PCO) | PCO | 0 |
| Configuration Options | | IE on the S5/S8 interface, if available and if ePCO is not | | |
| (PCO) | | supported by the UE or the network. The PCO IE shall | | |
| | | carry a P-CSCF address list only when the UE is required | | |
| | | to perform an IMS registration, e.g during the P-CSCF | | |
| | | restoration procedure as defined in clause 5.1 of 3GPP TS | | |
| | | 23.380 [61]. | | |
| | | This bearer level IE takes precedence over the PCO IE in | | |
| | | the message body if they both exist. | | |
| | | If the SGW receives this IE, the SGW shall forward it to the | | |
| | | SGSN/MME on the S4/S11 interface. | | |
| | CO | The PGW shall include the Prococol Configuration Options | | |
| | | (PCO) IE on the S2a interface, including the list of | | |
| | | available P-CSCF addresses, as part of the P-CSCF | | |
| | | restoration extension procedure for the TWAN access, as | | |
| | | specified in 3GPP TS 23.380 [61]. | | |
| | | This bearer level IE takes precedence over the PCO IE in | | |
| | | the message body if they both exist. | | |
| Additional Protocol | CO | The PGW shall include the Additional Prococol | Additional | 0 |
| Configuration Options | | Configuration Options (APCO) IE on the S2b interface, | Protocol | |
| (APCO) | | including the list of available P-CSCF addresses, as part of | Configuration | |
| | | the P-CSCF restoration extension procedure for the | Options (APCO) | |
| | | untrusted WLAN access, as specified in 3GPP TS 23.380 | | |
| | | [61]. | | |
| Extended Protocol | CO | The PGW shall include Extended Protocol Configuration | ePCO | 0 |
| Configuration Options | | Options (ePCO) IE on the S5/S8 interface, if available and | | |
| (ePCO) | | if the UE and the network support ePCO. The ePCO IE | | |
| | | shall carry a P-CSCF address list only when the UE is | | |
| | | required to perform an IMS registration, e.g during the P- | | |
| | | CSCF restoration procedure as defined in clause 5.1 of | | |
| | | 3GPP TS 23.380 [61]. | | |
| | | If the SGW receives this IE, the SGW shall forward it to the | | |
| | | MME on the S11 interface. | | |
| Maximum Packet | O | This IE may be included on the S5/S8 interfaces if the | Maximum Packet | 0 |
| Loss Rate | | PGW needs to send Maximum Packet Loss Rate as | Loss Rate | |
| | | specified in clause 5.4.2.1 of 3GPP TS 23.401 [3]. This IE | | |
| | | is only applicable for QCI 1. | | |
| | CO | If the SGW receives this IE, it shall forward it to the MME | | |
| | | on the S11 interface | | |

TABLE 7.2.15-3
Load Control Information within Update Bearer Request
Octet 1 Load Control Information IE Type = 181 (decimal)
Octets 2 and 3 Length = n
Octet 4 Spare and Instance fields

| Information elements | P | Condition/Comment | IE Type | Ins. |
|---|---|---|---|---|
| Load Control | M | See clause 12.2.5.1.2.1 for the description and use of this | Sequence | 0 |
| Sequence Number | | parameter. | Number | |
| Load Metric | M | See clauses 12.2.5.1.2.2 and 12.2.5.1.2.3 for the | Metric | 0 |
| | | description and use of this parameter. | | |
| List of APN and | CO | The IE shall (only) be present in the “PGW's APN level | APN and Relative | 0 |
| Relative Capacity | | Load Control Information” IE. | Capacity | |
| | | For indicating the APN level load, the PGW shall include | | |
| | | one or more instances of this IE, up to maximum of 10, | | |
| | | with the same type and instance value, representing a list | | |
| | | of APN(s) & its respective “Relative Capacity” (sharing the | | |
| | | same “Load Metric”). | | |
| | | See clause 12.2.5.1.2.3 for the description and use of this | | |
| | | parameter. | | |
| | | See NOTE 1. | | |

NOTE 1:
If more than 10 occurrences of “APN and Relative Capacity” IE are received within one instance of the Load Control Information IE, the receiver shall treat it as a protocol error and ignore the entire Load Control Information IE instance.

TABLE 7.2.15-4
Overload Control Information within Update Bearer Request
Octet 1 Overload Control Information IE Type = 180 (decimal)
Octets 2 and 3 Length = n
Octet 4 Spare and Instance fields

| Information elements | P | Condition/Comment | IE Type | Ins. |
|---|---|---|---|---|
| Overload Control | M | See clause 12.3.5.1.2.1 for the description and use of this | Sequence | 0 |
| Sequence Number | | parameter. | Number | |
| Overload Reduction | M | See clauses 12.3.5.1.2.3 and 12.3.5.1.2.4 for the | Metric | 0 |
| Metric | | description and use of this parameter. | | |
| Period of Validity | M | See clause 12.3.5.1.2.2 for the description and use of this | EPC Timer | 0 |
| | | parameter. | | |
| | | This IE should be set to “0” if the “Overload Reduction | | |
| | | Metric” is null. This IE shall be ignored by the receiver if the | | |
| | | “Overload Reduction Metric” is null. | | |
| List of Access Point | CO | [The IE may (only) be present in the “PGW's Overload | APN | 0 |
| Name (APN) | | Control Information” IE. | | |
| | | For indicating the APN level overload, the PGW shall | | |
| | | include one or more instances of this IE, up to maximum of | | |
| | | 10, with the same type and instance value, representing a | | |
| | | list of APN(s) (sharing the same “Overload Reduction | | |
| | | Metric” and “Period of Validity”). | | |
| | | See NOTE 1. | | |

NOTE 1:
If more than 10 occurrences of APNs are received within one instance of the Overload Control Information IE, the receiver shall treat it as a protocol error and ignore the entire Overload Control Information IE instance.

TABLE 7.2.15-5
PGW Change Info within Update Bearer Request
Octet 1 PGW Change Info IE Type = 214 (decimal)
Octets 2 and 3 Length = n
Octet 4 Spare and Instance fields

| Information elements | P | Condition/Comment | IE Type | Ins. |
|---|---|---|---|---|
| PGW Set FQDN | O | This IE may be included by a PGW if the PGW Set FQDN | PGW Set FQDN | 0 |
| | | is changed. | | |
| Alternative PGW- | O | This IE may be included by a PGW if the list of alternative | IP Address | 0 |
| C/SMF IP Address | | PGW-C/SMF IP addresses is changed | | |
| | | Several IEs with the same type and instance value may be | | |
| | | included to represent a list of Alternative PGW-C/SMF IP | | |
| | | Addresses. | | |
| New PGW-C/SMF IP | C | This IE shall be included by a PGW if the PGW S5/S8 IP | IP Address | 1 |
| Address | | Address for the control plane for the PDN connection is | | |
| | | required to be changed (see PGW triggered PDN | | |
| | | connection restoration in clause 31.4 of of | | |
| | | 3GPP TS 23.007 [17]). | | |
| New SGW-C IP | O | This IE may be included by a combined SGW/PGW to | IP Address | 3 |
| Address | | contain the SGW S11 IP address which the MME should | | |
| | | send the Create Session Request message towards. | | |
| | | during a MME triggered PDN connection restoration | | |
| | | procedure, as specified in clause 31.3 of of | | |
| | | 3GPP TS 23.007 [17]. | | |
| PGW-C/SMF FQ-CSID | C | This IE shall be included if the New PGW-C/SMF IP | FQ-CSID | 0 |
| | | Address IE is present and if the PGW-C/SMF requests the | | |
| | | MME to re-establish all the PDN connections associated | | |
| | | with a PGW-C/SMF FQ-CSID towards the PGW-C | | |
| | | indicated in New PGW-C/SMF IP Address IE. | | |
| | | When present, it shall contain the PGW-C/SMF FQ-CSID | | |
| | | for which the PDN connections are requested to be re- | | |
| | | established. | | |
| | | Several IEs with the same IE type may be present to | | |
| | | represent several FQ-CSIDsof PDN connections that need | | |
| | | to be moved to the New PGW-C/SMF IP Address. | | |
| | | See also clause 31.x of 3GPP TS 23.007 [17]. | | |
| Group Id | C | This IE shall be included if the New PGW-C/SMF IP | Group Id | 0 |
| | | Address IE is present and if the PGW-C/SMF requests the | | |
| | | MME to re-establish all the PDN connections associated | | |
| | | with a Group Id towards the PGW-C indicated in New | | |
| | | PGW-C/SMF IP Address IE. | | |
| | | When present, it shall contain the Group Id for which the | | |
| | | PDN connections are requested to be re-established. | | |
| | | Several IEs with the same IE type may be present to | | |
| | | represent several Group Ids of PDN connections that need | | |
| | | to be moved to the New PGW-C/SMF IP Address. | | |
| | | See also clause 31.x of 3GPP TS 23.007 [17]. | | |
| PGW Control Plane IP | C | This IE shall be included if the New PGW-C/SMF IP | IP Address | 2 |
| Address | | Address IE is present and if the PGW-C/SMF requests the | | |
| | | MME to re-establish all the PDN connections of which | | |
| | | PGW S5/S8/S2a/S2b F-TEID contains the PGW Control | | |
| | | Plane IP Address towards the PGW-C indicated in New | | |
| | | PGW-C/SMF IP Address IE. | | |
| | | Several IEs with the same IE type may be present to | | |
| | | represent several PGW-C/SMF IP addresses of PDN | | |
| | | connections that need to be moved to the New PGW- | | |
| | | C/SMF IP Address. | | |
| | | See also clause 31.x of 3GPP TS 23.007 [17]. | | |
| New Group Id | O | The IE may be present if the PGW-C/SMF wants to | Group Id | 1 |
| | | allocate a new Group Id for the PDN connection. When | | |
| | | present, this IE shall identify the new Group Id to which the | | |
| | | PDN connection pertains, and the MME shall replace any | | |
| | | earlier Group ID received for the PDN connection with the | | |
| | | new Group ID. If absent, the Group ID associated earlier to | | |
| | | the PDN connection, if any, shall remain unchanged. | | |
| | | See also clause 31.x of 3GPP TS 23.007 [17]. | | |

1. A method performed by a core network node, the method comprising:
establishing one or more Packet Data Network, PDN, connections with a first combined SGW/PGW/SMF, wherein:
the first combined SGW/PGW/SMF is comprised in a combined SGW/PGW/SMF set; and
a SGW of the first combined SGW/PGW/SMF has a first address;
receiving a notification of an SGW address change for the one or more PDN connections, the notification of the SGW address change comprising a second address of a SGW of a second combined SGW/PGW/SMF, the second combined SGW/PGW/SMF being comprised in the combined SGW/PGW/SMF set; and
initiating a PDN connection restoration procedure towards the SGW of the second combined SGW/PGW/SMF using the second address of the SGW of the second combined SGW/PGW/SMF comprised in the notification of the SGW address change.

2. The method of claim 1 wherein combined SGW/PGW/SMFs in the combined SGW/PGW/SMF set are interchangeable such that existing user plane entities for the one or more PDN connections are reused.

3. The method of claim 1 wherein combined SGW/PGW/SMFs in the combined SGW/PGW/SMF set are interchangeable such that user plane GTP tunnel endpoints in a RAN node and SGW-U node used for user plane traffic for the one or more PDN connections are not impacted.

4. The method of claim 1, wherein receiving the notification of the SGW address change comprises receiving the notification of the SGW address change from the second combined SGW/PGW/SMF.

5. The method of claim 1, wherein receiving the notification of the SGW address change comprises receiving the notification of the SGW address change from the first combined SGW/PGW/SMF.

6. The method of claim 1, wherein receiving the notification of the SGW address change comprises receiving the notification of the SGW address change from a combined SGW/PGW/SMF, other than the first combined SGW/PGW/SMF or second combined SGW/PGW/SMF, in the combined SGW/PGW/SMF set.

7. The method of claim 1, wherein receiving the notification of the SGW address change comprises receiving the notification of the SGW address change after the first combined SGW/PGW/SMF has failed or otherwise gone offline.

8. The method of claim 1, wherein initiating the PDN connection restoration procedure comprises sending a create session request message for each of the one or more PDN connections to be restored to the SGW of the second combined SGW/PGW/SMF using the second address of the SGW of the second combined SGW/PGW/SMF comprised in the notification of the SGW address change.

9. The method of claim 8 wherein the second address of the SGW of the second combined SGW/PGW/SMF is an IP address or FQDN.

10. The method of claim 1, wherein the notification of the address change comprises a create/update/delete bearer request messages comprising one or more PGW Change Info IEs, at least one of which comprises the second address of the SGW of the second combined SGW/PGW/SMF.

11. The method of claim 1, wherein the notification of the address change comprises a create/update/delete bearer request comprising one or more PGW Change Info IEs, at least one of which comprises an IE that comprises the second address of the SGW of the second combined SGW/PGW/SMF.

12. The method of claim 1, wherein the core network node is an MME.

13. A method performed by a combined SGW/PGW/SMF, the method comprising:
sending, to a core network node, a notification of an SGW address change for one or more PDN connections that are using a first combined SGW/PGW/SMF, wherein:
the first combined SGW/PGW/SMF is comprised in a combined SGW/PGW/SMF set;
a SGW of the first combined SGW/PGW/SMF has a first address; and
the notification of the SGW address change comprising a second address of a SGW of a second combined SGW/PGW/SMF, the second combined SGW/PGW/SMF being comprised in the combined SGW/PGW/SMF set.

14. The method of claim 13 wherein the combined SGW/PGW/SMF is the second combined SGW/PGW/SMF.

15. The method of claim 13 wherein the combined SGW/PGW/SMF is the first combined SGW/PGW/SMF.

16. The method of claim 13 wherein the combined SGW/PGW/SMF is a combined SGW/PGW/SMF, other than the first combined SGW/PGW/SMF or second combined SGW/PGW/SMF, in the combined SGW/PGW/SMF set.

17. The method of claim 13, further comprising determining that a change of a serving SGW and/or a serving PGW for the one or more PDN connections is needed (e.g., because the serving SGW or serving PGW has failed or to rebalance the load among the combined SGW/PGW/SMFs in the set).

18. The method of claim 13 further comprising receiving, from the core network node, a message that initiates a PDN connection restoration procedure towards the second combined SGW/PGW/SMF based on the notification of the SGW address change, wherein the PDN connection restoration procedure restores the one or more PDN connections with the second combined SGW/PGW/SMF.

19. The method of claim 13 wherein sending the notification of the SGW address change comprises sending the notification of the SGW address change after the first combined SGW/PGW/SMF has failed or otherwise gone offline.

20. The method of claim 13, wherein notification of the address change comprises a new SGW address.

21. The method of claim 20 wherein the second address of the SGW of the second combined SGW/PGW/SMF is an IP address or FQDN.

22. The method of claim 20 wherein the notification of the SGW address change comprises a create/update/delete bearer request comprising one or more PGW Change Info IEs, at least one of which comprises the second address of the SGW of the second combined SGW/PGW/SMF.

23. The method of claim 20 wherein the notification of the SGW address change comprises a create/update/delete bearer request comprising one or more PGW Change Info IEs, at least one of which comprises an IE that comprises the second address of the SGW of the second combined SGW/PGW/SMF.

24. The method of claim 13, wherein the core network node is an MME.

25. (canceled)

26. A core network node comprising processing circuitry configured to cause the core network node to:
establish one or more Packet Data Network, PDN, connections with a first combined SGW/PGW/SMF, wherein:
the first combined SGW/PGW/SMF is comprised in a combined SGW/PGW/SMF set; and
a SGW of the first combined SGW/PGW/SMF has a first address;
receive a notification of an SGW address change for the one or more PDN connections, the notification of the SGW address change comprising a second address of a SGW of a second combined SGW/PGW/SMF, the second combined SGW/PGW/SMF being comprised in the combined SGW/PGW/SMF set; and
initiate a PDN connection restoration procedure towards the SGW of the second combined SGW/PGW/SMF using the second address of the SGW of the second combined SGW/PGW/SMF comprised in the notification of the SGW address change.

27. A combined SGW/PGW/SMF comprising processing circuitry configured to cause the combined SGW/PGW/SMF to:
send, to a core network node, a notification of an SGW address change for one or more PDN connections that are using a first combined SGW/PGW/SMF, wherein:
the first combined SGW/PGW/SMF is comprised in a combined SGW/PGW/SMF set;
a SGW of the first combined SGW/PGW/SMF has a first address; and
the notification of the SGW address change comprising a second address of a SGW of a second combined SGW/PGW/SMF, the second combined SGW/PGW/SMF being comprised in the combined SGW/PGW/SMF set.
